(19) United States
(12) Patent Application Publication
(10) Pub. No.: US 2004/0015376 A1
(43) Pub. Date: Jan. 22, 2004

(54) Method and system to value projects taking into account political risks

(75) Inventors: Kai Zhu, Houston, TX (US); Helen Alise El Mallakh, Houston, TX (US)

Correspondence Address: Cheryl S. Ratcliffe, Conoco Inc., P.O. Box 4783, Houston, TX, 77210-4783, US

(73) Assignee: CONOCO INC.

(21) Appl. No.: 10/189,936

(22) Filed: Jul. 3, 2002

(51) Int. Cl. G06F 17/60

(52) U.S. Cl. 705/7

(57) ABSTRACT

A method and system which deal with the evaluation of the impact of political risk on forecast and value of a project. Key macro political risks are identified and quantified. Project specific political risk events that can result from changes in macro political uncertainties are identified and the probabilities quantified. The relationship of the macro political risks and project specific political risk events are defined. The key project economic parameters susceptible to political uncertainties are identified and the threshold or changes in economic parameters upon the occurrence of a risk event are quantified. The data is assembled into a computer system and a Monte Carlo analysis can be preformed to forecast the probable value of the project taking into account potential political risks.

### TECHNICAL FIELD

The present invention relates to a method and system for the economic analysis of projects or investments which takes into account risks associated with political uncertainties.

### BACKGROUND OF THE INVENTION

For years, companies have engaged in economic value analysis of projects to make investment decisions. A number of economic valuation metrics, such as EMV-Expected Monetary Value, NPV-Net Present Value and IRR-Internal Rate of Return are used in selecting whether one competing project opportunity should be pursued over another. For convenience the term “project or projects” shall refer to either equity investments or intangible investments.

As world commerce becomes further integrated, many companies invest in projects or investments in multiple legal jurisdictions. These multiple jurisdictions can be different sovereign countries, or different political subdivisions within the same country, such as the individual cities, counties and states of the United States, or different political subdivisions in different countries. In many areas of the world, the political environment and the host government may be unstable. These instabilities can result in dramatic changes which can eliminate the value of the project or substantially reduce the value of the project. For example, rise of a nationalistic government could result in confiscation of project assets, or a terrorist attack on the manufacturing facility could result in production disruptions, etc.

Despite the significant potential impact to investment value, businesses frequently fail to account for political uncertainties in their investment economic analysis. When political risks were considered in the evaluation of projects, the quantification of the risks involved, if done at all, was usually made on a very subjective basis. Many times an arbitrary country risk premium was selected for a particular country to account for overall political risks associated with a project in that country, e.g. 0% for U.S., 5% for Mexico, and 10% for Russia. In practice, these risk premiums are applied as hurdle rates against which the potential return of the contemplated project are measured to gauge the attractiveness of the project. If a project cannot generate a return that exceeds the hurdle rate, it is typically not pursued. In other words, assuming that the hurdle rate that is required to be exceeded is a U.S. project that has a 10% hurdle rate, then the hurdle rate for a Mexican project would be 15% (10% U.S. hurdle rate+5% Mexican country risk premium), and 20% for a project in Russia (10% U S. hurdle rate+10% Russian country risk premium). By the same token, a project that returns 18% on an annual basis would be very attractive if it were located in the U.S.; however, it would be considered sub-par if located in Russia. In addition to being arbitrary, this approach is theoretically flawed and may result in incorrect investment decisions.

As such, there has been a need for a method to objectively and appropriately evaluate project opportunities which not only accounts for the theoretical economic opportunity, but also the risk that the economic opportunity will be affected by political uncertainties. There is also a need for the evaluation to be done in a systematic manner so that projects in various industries across various jurisdictions can be evaluated and/or compared applying consistent criteria. Further, there has been a continuing need for a system which allows reevaluation of the political risks and the effect on project value on a continuing basis. Also, there has been a continuing need to develop a historical database to provide information to permit more refined political risk analysis of projects in the future based on past experience.

The present invention is designed to meet all the above needs. The invention provides for quantifying the likelihood of political risk events and their effects on a project's forecasted cash flow in a systematic and rigorous fashion. The analysis can rely on a combination of expertise from internal company sources or external sources, or both. The invention offers the advantage of a system which allows the impact of political risks on project economics to be understood and managed. The invention also allows for the incorporation of political-related “shock events” such as extreme commodity price fluctuations or “windfall project” profits in the economic analysis. Political-related “shock events” are events, either exogenous or endogenous, that may alter the political equilibrium between project owners/sponsors and the host government. Furthermore, the invention has the advantage that it is easily adapted to and customized to analyze any type of project in any industry.

### SUMMARY OF THE INVENTION

The present invention provides a system, program, and method which allows the value of projects to be evaluated in light of potential political risks at the macro jurisdictional level (e.g. country level) and at the project specific level.

In one aspect, the invention relates to a computer system for assessing a project in light of political risks. The system includes means to input project economic parameters and means to compute a project value based on inputted economic information. The system also includes means to input quantification of macro political risks over the expected life span of the project. These macro political risks may include general governmental policies regarding taxation, import/export regulations, risk of engaging in trade wars, risk of a change in government due to political unrest, etc. The system also provides means to input quantification of conditional project manifestation risk probabilities over the expected life span of the project to assess the project specific political risks. Project specific political risk events can include renegotiation of contracts, confiscation or nationalization of project assets, and restrictions on repatriation of profit/dividend, etc. Project specific political risk events may result from changes in the macro political environments. The inputted quantification of macro political risks and conditional project manifestation risks can be processed to estimate each aggregate project specific risk probability. In the preferred embodiment, the invention includes a means to define and input the timing of risks which allows the risk events to be associated with project stages. The system also includes means to calculate the economic impact of the political risks by applying an algorithm which represents a predetermined relationship of said macro political risks and said project specific political event risks with one or more of the project economic parameters. These project economic value parameters are those parameters (e.g., the amount and timing of costs, revenues, growth rates, corporate tax rate, and other data) commonly used to forecast the cash flows of an investment and the potential return of the investment. The system also includes means to simulate many possible political scenarios across the expected life span of the project and apply a probabilistic assessment to determine a statistical distribution of the project economic parameters under various political outcomes. Further, the system can include an output means for making the risked project economic parameter distributions available for use in assessing the overall value of the project. The output of this output means can be linked to a project economic model to calculate the risked economic value metrics of the investment (e.g., EMV, NPV and IRR) upon which the investment decision can be made. In a preferred embodiment, means for excluding one or more of the project specific risks as possible variables in the value computation is provided. This allows one to conduct a sensitivity evaluation to determine the magnitude of the various project specific risks with respect to each other and the risked project value. From hereon, unrisked economics refers to project economics that capture the uncertainties of a commercial, operating, or technical nature, without taking into account how political uncertainties could impact investment valuations. Risked economics refers to project economics that not only capture the usual commercial, operating, or technical uncertainties, but also have taken into account how political uncertainties could impact investment valuations.

In another aspect, the invention relates to a computer program for analyzing project value taking into account political risks. The program is coded to receive input data for project economic parameters, quantification of at least one category of macro political risks, quantification of at least one project specific political event risk, and quantification of the economic impact on at least one project economic parameter upon the occurrence of a risk event. This program can include code that applies a multi-variant decision hierarchy scoring system to quantify various conditional project manifestation risk probabilities, by learning from past experience and calibrating against other projects or investments. The program also includes a novel program that conducts a statistical simulation to arrive at a plurality of iterations representing many possible political scenarios and to determine the effects of those events on the project economic parameters. The program also includes code to feed the changes in the project economic parameters for each iteration of the simulation as input to the economic model to compute risked project value metrics (e.g., EMV, IRR), which ultimately determines the real economic viability of the project. Further, the program can include code that bring various political-related “shock events” into the system to analyze the investment outcomes under extreme cases. In a preferred embodiment, the program also includes program code which allow for outputting statistical distributions of project values determined from multiple iterations. This computer code can be in separate modules, or can be combined into a program that performs all the desired functions (e.g., generating statistical distributions, conducting probability analysis and estimating risked project values) in one program.

In another aspect, the invention relates to a method for evaluating the impact of political risks on project value. Both forecasted and actual project economic parameters are assembled. Typically, the economic parameters will be in the nature of projections or forecasts; however, because the present method can be used for re-evaluation of project value during the term of the project, actual economic data, forecasted economic data, and combinations thereof can also be used. To provide a thorough assessment, the project life span can be divided into a manageable number of sub-periods, each of which can have a distinctive political risk profile. Macro political risks which could have a statistically significant impact on the project are identified. In a preferred embodiment, the macro political risks are classified into macro political risk categories of at least one macro political risk. In a preferred embodiment, macro political categories are limited to three to ten categories to simplify calculations. The risk of an occurrence of each macro political risk category during each of the sub-periods defined is quantified. The project specific political event risks are identified and the conditional probabilities of an occurrence of each project manifestation during each sub-period are quantified. Project economic parameters which may be exposed to political uncertainties are identified, and the changes in each of the parameters result from the occurrence of project specific political risk events are quantified. The relationship between the macro political risks categories, project specific political events and project economic parameters are established. One such relationship example is provided, in FIG. 1 which is an influence diagram for an oil & gas upstream (exploration and development) investment, with the macro political risk categories (in the inner ring 40) driving project specific political risk events (the middle ring 42), which in turn may cause changes in project economic parameters (outer ring 44). The information is inputted into a computer system and multiple risks scenario are generated and their impacts on project value are determined. In a preferred embodiment, the result of the risks analysis are stored and compared with the results computed for other projects.

### BRIEF DESCRIPTION OF THE DRAWINGS AND APPENDIXES

Drawings

The present invention will be better understood with reference to the detailed description together with the drawings in which:

FIG. 1 is an influence diagram that illustrates the causal relationship between macro political risk categories, project specific political event risks, and project economic parameters for an oil & gas upstream investment (FIG. 1 is not an exhaustive presentation but is merely illustrative);

FIG. 2A is a flow chart representing the assemblage of data and the implementation of the political risk assessment with respect to a method of the present invention;

FIG. 2B is a continuation of the flow chart of FIG. 2A;

FIGS. 3A-3E illustrate the five-year cumulative probabilities of the five macro political risks categories for various countries, starting from Q1, 2001;

FIG. 4A is a graph showing a statistical timing distribution that allocates cumulative probabilities equally over the years in the time period;

FIG. 4B is a graph showing a statistical timing distribution that allocates cumulative probabilities unequally over the years in the time period;

FIGS. 5A-5D are worksheets in accordance with an embodiment of the present invention that illustrate the multi-variant decision hierarchy scoring system that assists users in quantifying conditional project manifestation probabilities;

FIGS. 6A-6B is a worksheet in accordance with an embodiment of the present invention for an upstream oil and gas investment. This worksheet illustrates the quantifications of macro political risk probabilities, conditional project manifestation probabilities, and the assumptions on the relationship between macro political risks and project specific political event risks. This sheet also illustrates calculations to derive aggregate cumulative probabilities project event risks;

FIGS. 7A-7B is a worksheet in accordance with an embodiment of the invention for a power plant investment;

FIG. 8 is a worksheet in accordance with an embodiment of the invention for an investment in sovereign bonds;

FIGS. 9A-9D illustrates another worksheet in accordance with an embodiment of the invention for upstream oil and gas investments, illustrating input estimates for various project economic parameters upon the occurrence of a particular project specific political risk event;

FIGS. 10A-10B is the worksheet similar to FIGS. 9A-9D but for a power plant investment (same investment as in FIGS. 7A-7B);

FIGS. 11A-11B illustrate an intermediate output from the present invention which is used to feed the results of the simulation to the economic model where the risked value matrices (NPV, IRR) are derived. This output is for upstream oil and gas investments and numbers (flags) in the figure represent the results of single Monte Carlo iteration;

FIGS. 11C-11D are the results of another iteration from that of FIGS. 11A-11B;

FIGS. 12A-12B illustrates an intermediate output from the present invention which is customized for power plant investments and numbers (flags) in the figure represent results of a single Monte Carlo iteration;

FIGS. 12C-12D are the results for another iteration from that of FIGS. 12A-12B;

FIG. 13 is another flow chart illustrating the Monte Carlo simulation process, and comparing the differences in the processes of deriving risked and unrisked project value;

FIG. 14 is an illustration showing possible risks scenarios (decision branches), using Monte Carlo analysis, for a hypothetical four-year project which has only one economic parameter, one macro risk category and one defined macro category for illustrative purposes;

FIG. 15 illustrates the outcomes of an oil & gas investment analysis that relies upon the output from the present invention, showing the effects of each project risk event on the overall project value;

FIG. 16 is a schematic illustration of a computer network useful in the present invention.

### DETAILED DESCRIPTION OF THE INVENTION

The present invention can be used to evaluate a number of projects including equity investments and investments in intangibles. Further, it is understood that the present method and system can be used with all types of industries and projects such as automobile manufacturing facilities, electronic manufacturing facilities, mining, etc. The method and system of the present invention can also be applied in the analysis of financial investments such as bonds and other securities. In addition, this system may also be used in evaluating risks at various jurisdictions at levels, such as country, state, province, municipal or other political subdivisions.

For purposes of illustration, a preferred embodiment will be explained utilizing an upstream (exploration and production) petroleum project, and will utilize countries as the political jurisdiction for which the impact of political risks are evaluated. An upstream petroleum project can include such activities as drilling a well, placing the well in production, and transporting the petroleum products to a refinery or to exporting facilities.

Like most businesses, a petroleum company typically has limited funds to invest, and has opportunities to invest which exceed available funding. These investment opportunities may be in many different countries, such as Venezuela, Nigeria, Algeria, Saudi Arabia, Vietnam, one of the former Soviet Republics, etc. The present method and system provides the manager with a tool to use in selecting which one of multiple opportunities should be pursued, and to periodically reevaluate a project to determine if it should be continued. The present method and system provides the business manager with not only the potential unrisked economic return (or “baseline worth” or “baseline value”) based on the typical economic model for project in question, but also the potential risked/true return (or “risked project worth” or “risked project value”) incorporating the impacts of political risks which may occur. The present method and system also provides the business manager with information that can be used in considering diversification of risk. For example, a business manager may forego making an additional investment in one country where it is already operating in favor of one in another country to diversify the risk over different jurisdictions or potential risk events.

Overview

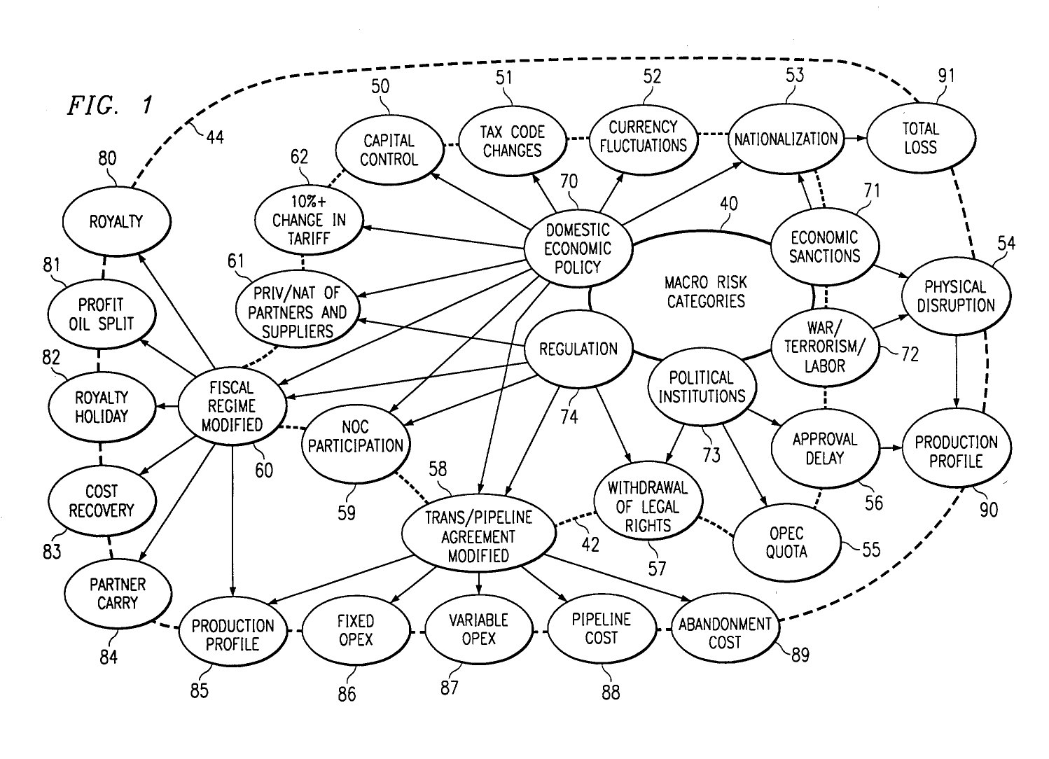

FIG. 1 illustrates the causal relationship (or influence relationship) between macro political risks/categories and project specific risk events, and their impact on project economic parameters, using the embodiment of the upstream project in Russia for purposes of illustration of a process of the invention. Due to space constraints, only selected relationships are shown. The macro country political risk categories are labeled numbers 70 through 74. The macro country risks manifest themselves at the project level as project specific risk events, labeled numbers 50 through 62. The occurrence of a project specific event can result in changes in project economic parameters, labeled numbers 80 through 91. As seen in FIG. 1, a project specific risk can be related to one or more macro political risks categories and a project economic parameter can be related to one or more project specific risks.

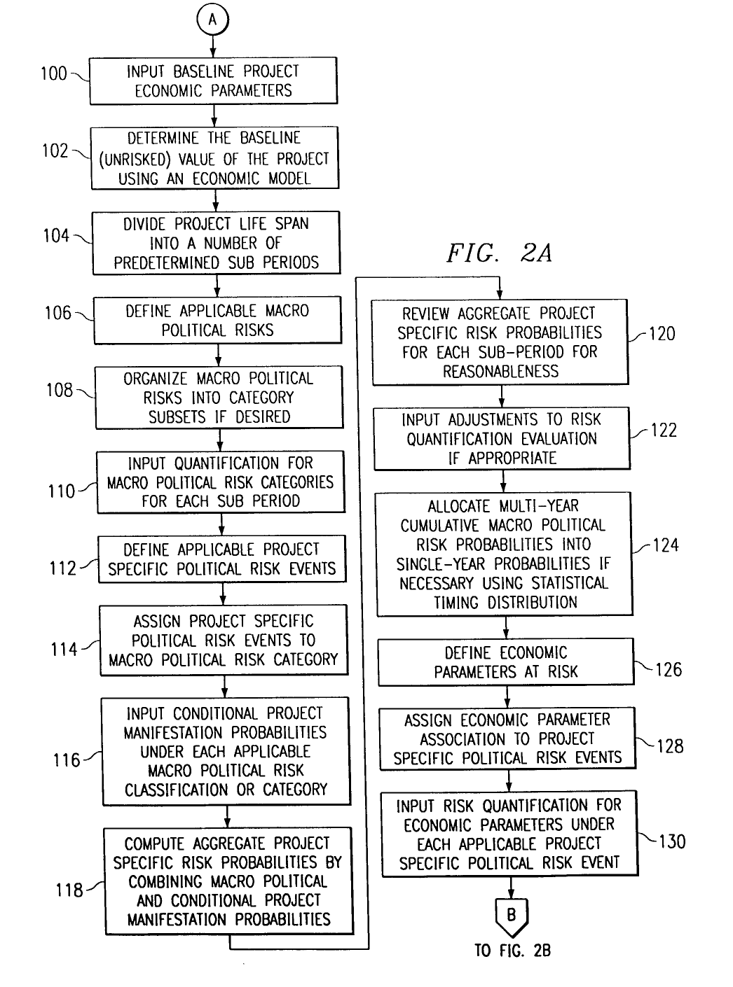

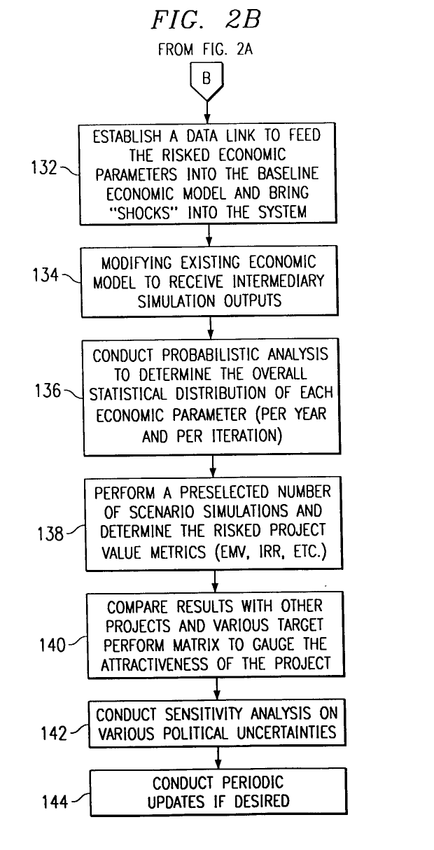

FIGS. 2A-2B is a flow chart that provides an overview of the methodology and the process employed with respect to the present invention. The steps do not necessarily have to be performed in the sequence illustrated. The project economic value parameters for the evaluation of the unrisked value (or base line value) of an investment are collected. Project economic value parameters can include investment costs, tax rate, royalty rate, production forecasts, price forecasts, timing of expenses and revenue, and other data commonly used to forecast the cash flows of an investment and the potential return on investment. These values are inputted to a predetermined economic model/computer program, (e.g., an Excel spreadsheet model) to estimate the unrisked base line value. The macro political risks which can likely affect the project economic parameters, hence the value of the project are identified and their probabilities of occurrence are quantified. Project specific political risk events are identified and their conditional probabilities of manifestation are quantified. Impacts on project economic parameters are defined for each occurrence of the project specific political risk event. For example, a confiscation of project assets by the government results in a loss of the entire value of the project, or in the event of a contract renegotiation, the corporate tax rate will be raised by 5 percentage points A probability analysis, such as a Monte Carlo analysis is performed to determine a risked project value taking into account the potential political uncertainties. (A Monte Carlo analysis is a well known probabilistic tool used in risk assessment.) This analysis can be done by using a spreadsheet program such as Microsoft Excel in conjunction with a statistical program, such as “Crystal Ball”, sold as an add-in for Excel by Decisioneering, Inc. The “Crystal Ball” program specializes in performing Monte Carlo analysis by applying a probability distribution to each uncertain variable and is effective in managing the iterative simulation process. The risked project value which takes into account political risk, can then be compared to the unrisked project value or baseline project value. Also, the results can be used to compare the risked project value of different projects for investment selection. The importance of using risked project values as opposed to using unrisked or baseline project values in investment selection are highlighted in the following examples (two projects are ranked using both EMV and IRR measures):

TABLE 1A
Investment Selection Based on EMV (Expected Monetary Value)

| | in U.S. | in Russia |
|---|---|---|
| Value of the project | $100 million | ✓ $120 million |
| excluding political risks | | |
| Value of the project | ✓ $80 million | $20 million |
| including political risks | | |

TABLE 1B
Investment Selection Based on IRR (Internal Rate of Return)

| | in U.S. | in Russia |
|---|---|---|
| Return of the project | 12% | ✓ 16% |
| excluding political risks | | |
| Return of the project | ✓ 11% | 9% |
| including political risks | | |

✓ denotes the better project

Suppose a company has two potential projects, one in the U.S. and the other in Russia, but only has sufficient funds to invest in one project. Excluding political risks, the project in Russia is worth more than the project in the U.S. However, factoring the political uncertainties, the U.S. project looks more attractive. Therefore, on the EMV basis, the company will elect to pursue the U.S. project. And on the IRR basis the company would elect the U.S. project as well.

The estimation of the Likelihood of Risk Event Occurrence

Referring to FIG. 2A, applicable project economic data parameters are inputted to the program by a means for inputting project economic value parameters, block 100. Input means in this application refers to any currently known input means or future developed means. An input means includes an input which is a user interface such as a keyboard, mouse, touch screen, voice recognition device, scanner, etc. An input means also includes an interface between different subroutines of a program, or an interface for data exchange between programs, or an interface between a processor and data storage devices. Input means can include a combination of the above, and the selection can be affected by user preference, program structure, degree of sophistication, etc. A computer program based on a predetermined economic model processes the economic data and computes an unrisked baseline project value, block 102, which does not include the potential impact of political risk events. The expected project life span can be divided into a manageable number of sub-periods, if applicable, each with distinctive political risk profiles to provide a differential political risk assessment, block 104. The relevant (to the project considered) macro political risks are identified, block 106. The macro risks are those at the predetermined jurisdictional level of interest, for example, on a country level. Depending on the number of macro political risks identified, it can be beneficial to organize the risks into a more limited number of categories, block 108. A category can be a single macro political risk or a combination of two or more macro political risks. Probabilities for each of the macro political risk categories over each sub-period are quantified (the probabilities can either be cumulative over a number of years, or can be cumulative over a single year) and inputted, blocks 110 and 112. The relevant project specific political risks are defined, block 112. The relationship of project specific political risks to one or more macro political risks or risk categories are assigned, block 114. The conditional project manifestation probability associated with each project specific political risk under each sub-period is quantified and inputted, block 116. The above are the preliminary stages of evaluation to provide inputs to estimate the likelihood of risk event occurrence. From the input, the aggregate project specific political events risk probabilities for the defined sub periods of the project are estimated by combining the macro political risk probabilities and the conditional project manifestation probabilities, block 118. At this time, one can review the results of the risk probabilities for various time periods and evaluate their reasonableness, block 120. If the aggregate risk probabilities do not appear reasonable, then the quantification process is reevaluated and appropriate adjustments are made and inputted, block 122. If multi-year cumulative probabilities are estimated in block 110, then they should be apportioned into single-year probabilities by defining a statistical timing distribution, block 124.

Estimation of the Economic Impact of the Risk Event Occurrence

Referring to FIGS. 2A and 2B, the project economic parameters that will likely be affected due to political uncertainties at the macro or project level are identified. The project economic parameters can be timing and amount of expenditures, revenues, production profiles, growth rates, royalty rates, etc., block 126. The association of economic parameters to one or more project specific political risks is assigned, block 128. The changes (economic ramifications) to project economic parameters upon occurrence of each project specific political risk are inputted, block 130. These values changes can be based on any appropriate reference, such as a contract provision or a magnitude of change in a factor (such as a change in tax rate) likely to result in the occurrence of an event.

Link the Modules and Conduct Simulation

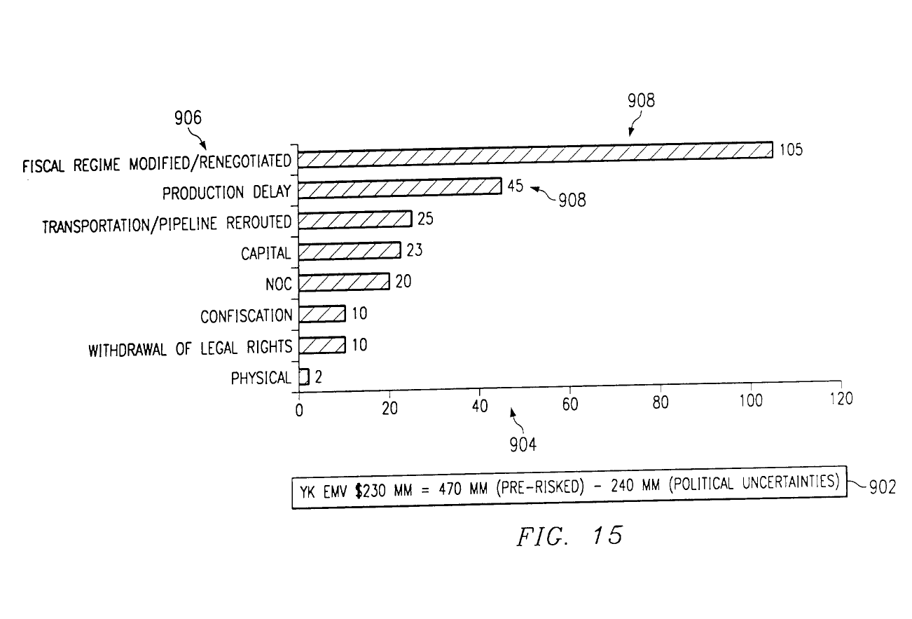

The computer system will then estimate the overall statistical distribution of each risked project parameter for each year of the project. A two-way dynamic data link should be established to (a) feed the results of the risk simulation to the baseline economic model and (b) to bring the political related “shocks” back to the simulation module. The “shocks” refer to extreme changes in commodity prices, profitability of the venture or any other items that can potentially induce strong government reaction and are of a political nature which have not been included thus far, block 132. For example, a large increase in the price of crude oil could tempt the host government to increase the tax rate on an upstream development project. The baseline economic model used to compute the unrisked project economic value is modified to receive the simulation outputs described in block 134. Once the data link is in place, a number of preselected iterations are performed to simulate various political outcomes based on the probabilities and economic ramifications defined. For each iteration of the simulation, the timing and severity of the political risks simulated, along with the resultant changes in the economic parameters are used by the economic module where the risked project values are computed, block 136. The overall outcomes are then collapsed into one set of final risked values (such as an average of all iterations: the Expected Monetary Value, Expected IRR; a percentile listing of the likelihood of various valuations), block 138. These risked project values can then be compared to other projects that require funding to prioritize the potential investments, block 140. In a preferred embodiment, a sensitivity analysis is conducted to determine the impact of each project specific risk on the project value, block 142. This may be outputted as shown in FIG. 15. Since political risks can be very fluid, the assumptions can be revisited and periodically updated to obtain the latest risked value of the project, block 144. The above overview is more fully explained below.

Expanded Explanation

a. Deriving Unrisked Project Value

One of the first steps, is to input the unrisked economic parameters of a project, not taking into account how they will potentially be impacted by political risks, into the project economic model, block 100. The input means for this data can be a user interface, an automated interface or combination thereof In the embodiment illustrated (an upstream oil & gas investment in Russia), these unrisked economic parameters include the estimated size of recoverable petroleum, length of time to complete wells and bring wells into production, estimates of potential daily production volume, costs associated with drilling, costs associated with transportation, forecast of prices for petroleum, costs of production, etc. In the preferred embodiment, these values are customarily determined on a yearly basis. This is convenient because it corresponds to the common accounting practice of making yearly budgets. The economic model will calculate unrisked project value from the inputted economic data, essentially assuming that no political risk events occur over the life of the project, block 102. This step is performed by any known computer program which represents the economic model for the project or any program that is written to represent an algorithm representing the economic model.

b. Dividing Project Life Span Into Time Periods

Many investments have expected life spans over 10 years. Since political environments often change during the expected life of a project, either because the host country's culture has changed or because of the project has changed, it may not be appropriate to assume that the political environment will stay the same throughout the life span of the project. Therefore, it is useful to carve up the entire project life span into a manageable number of distinctive sub-periods to allow for differential political exposure assessment, block 104. As such, the years within a same sub-period share a common political risk profile, while risk profiles may vary from one sub-period to another.

There are different ways of dividing the project life span into sub-periods. The division can be done along the timetable of the country's development, the milestones of the project or a combination of both. In the case of tangible investments, the milestones of the project, are clearly observable. For an automobiles manufacturing facility, or a natural resource mining investment, there are generally several distinctive periods: i.e., a period of time during which there is pre-production capital investment and a subsequent time period when the facility is in start-up production, followed by a period of maturing production and then a period of declining production. Where a project relates to intangible investments such as investments in bonds and securities, there are no comparable production time frames, then division along the timetable of the country's development may be useful. For example, the expected life span of the intangible investment can be divided into appropriate segments, such as five years each. Shorter sub-periods (which means greater number of sub-periods) provides better resolution for the analysis, but also introduces more complexities into the simulation. In practice, the length of each sub-period is dependent on the type and duration of the investment. For long term investments (over 10 years), it is useful to divide the project into 2 to 5 sub-periods of 2 to 5 years in length.

In the embodiment illustrated (an upstream oil & gas investment in Russia), the project is divided into two sub-periods using a combination of the above two approaches: the pre-production period starts in 2001 and ends in 2008, and the in-production period starts in 2009 and ends in 2025. The two periods face very distinctive political risk exposures since it is widely known that in the petroleum industry, the pendulum usually shifts in the host government's favor once foreign firms have committed capital and resources. However, this shift in leverage is partially offset by the expectation of improvement in the general operating environment of the country as time passes.

c. Determining Macro Political Risks

The macro political risks are evaluated for the political jurisdiction of interest. In the illustrated embodiment, the macro political risks are on a country level. There are a significant number of macro political risks, of various significance to different type projects such as oil and gas investments, power plant investments or bond investments. While potently each of the macro political risk could be considered and utilized in the present invention, a selection of the more statistically significant political risks is preferred to simplify the process and to allow a more rapid assessment. Thus, the more relevant (to the type of investment at-hand) macro political risks are identified, block 106. Most commonly known macro political risks are provided below with the risks considered especially applicable to the illustrated projects checked:

Commonly Known Macro Political Risks:

| | | |
|---|---|---|
| ✓ | 1. | Corporate Capital Gains Tax Risk |
| ✓ | 2. | Corporate Income Tax Risk |
| ✓ | 3. | Export Tax Risk |
| ✓ | 4. | Import Tax Risk |
| | 5 | Labor Tax Risk |
| ✓ | 6. | Withholding Tax Risk |
| ✓ | 7. | Enforceability of Gov. Contracts Risk |
| ✓ | 8. | Enforceability of Private Contracts Risk |
| | 9. | Ownership of Business by Non-Residents |
| | 10. | Ownership of Equities by Non-Residents Risk |
| ✓ | 11. | Environmental Regulations Risk |
| ✓ | 12. | Export Regulations Risk |
| ✓ | 13. | Import Regulations Risk |
| | 14. | Transferability of Funds risk |
| | 15. | Currency Depreciation Risk |
| | 16. | Currency Appreciation Risk |
| ✓ | 17. | Inflation Risk |
| ✓ | 18. | Default/Restructuring by Bank Risk |
| ✓ | 19. | Default/Restructuring on Govt. Loans Risk |
| ✓ | 20. | Domestic Demand Risk |
| | 21. | Export Disruption Risk |
| | 22. | Import Disruption Risk |
| | 23. | Infrastructure Disruption or Shortage Risk |
| ✓ | 24. | Corruption Risk |
| | 25. | Crime Risk |
| | 26. | Skilled-Labor Shortages Risk |
| ✓ | 27. | Military Coup Risk |
| ✓ | 28. | Major Insurgency/Rebellion Risk |
| ✓ | 29. | Terrorism Risk |
| | 30. | Assassination Risk |
| ✓ | 31. | Civil War Risk |
| | 32. | Major Urban Riot Risk |
| ✓ | 33. | Labor Strike and Unrest Risk |
| | 34. | Kidnapping of Foreigners Risk |
| | 35. | Government Instability Risk |
| ✓ | 36. | Government Ineffectiveness Risk |
| ✓ | 37. | Institutional Failure Risk |
| ✓ | 38. | Economic Sanctions Risk |
| ✓ | 39. | Trade Conflict Risk |
| ✓ | 40. | Military Mobilization/Small Inter-State War Risk |
| ✓ | 41. | Major Inter-State War Risk |

Depending on the number of macro political risks selected, it can be useful to group those risks into categories and to treat the category as a whole, block 108. A category could be made up of one or more individual macro political risks. Preferably, the categories combine macro political risks that are related or may have similar impacts on the project. In the illustrated embodiment of an upstream oil production investment, it was found useful to group the macro country risks into five categories. These five categories were assigned names: “Domestic Economic Risk”, “Regulations Risk”, “Economic Sanctions Risk”, “Political Institutions Risk”, and “War/Terrorism/Labor Risk”. The descriptions for each macro political risk category and the macro political risks which are included in each categories are listed in the Table 2 below.

TABLE 2
Categorization of Macro Political Risks for an Upstream Oil & Gas Investment

| | | Regulations | | | War/Labor/ |
|---|---|---|---|---|---|
| | Domestic Economic | Risk | Economic | Political | Terrorism |
| | Risk | (non-economic) | Sanctions Risk | Institutions Risk | Risk |
| Definition | Macroeconomic driven | Non-economic | Government policy | Political institutions | Risks that arise |
| | policies that damage a | motivated | results in a decline or | are the “rules of the | from “rough” |
| | country's economy, | government | cessation of trade or | game” that govern | political actions, |
| | potentially impacting | changes in | investment (e.g., | the conduct of | such as riots and |
| | investors, customers and | regulations, laws | home or host country | political activity. | coups, labor |
| | suppliers (e.g., stagnating | affecting all firms | sanctions/embargoes, | Political institutions | strikes or major |
| | growth, recession, high | in the economy or | trade wars, | risks arise from the | wars. |
| | interest rates, rapid | all foreign firms | withdrawal from | state of political | |
| | inflation, etc.). | | trade or investment | institutions in the | |
| | | | agreements (IMF), | host country, such as | |
| | | | etc.) | the legal system, the | |
| | | | | bureaucracy, and the | |
| | | | | electoral system | |
| Macro Risks Included | 1) Domestic demand risk | 1) Environmental | 1) Economic | 1) Government | 1) Military coup |
| | 2) Default/restructuring | regulations risk | Sanctions risk | ineffectiveness | risk |
| | by bank risk | 2) Import | 2) Trade conflict risk | risk | 2) Major |
| | 3) Default/restructuring | regulations risk | | 2) Institutional | insurgency, |
| | on gov. loans risk | 3) Export risks | | failure risk | rebellion risk |
| | 4) Inflation risk | regulations risk | | 3) Corruption risk | 3) Terrorism risk |
| | 5) Corporate capital | | | 4) Enforceability of | 4) Civil war risk |
| | gains tax risk | | | gov. contracts | 5) Military |
| | 6) Corporate income tax | | | risks | mobilization/ |
| | risk | | | 5) Enforceability of | small inter- |
| | 7) Import tax risk | | | private contracts | state war risk |
| | 8) Export tax risk | | | risks | 6) Major inter- |
| | 9) Withholding tax risk | | | 6) Infrastructure | state war risk |
| | | | | shortages risk | 7) Labor strike |
| | | | | | and unrest |
| | | | | | risk |

For each category of risk defined, a multi-year cumulative probability or a single-year probability is quantified, block 110, to estimate the likelihood of any or all of the risks included in the category materializing during each project sub-period. For example, in the embodiment illustrated, the macro political risks that need to be quantified are: the “Domestic Economic Risks” for the pre-production period and for the in-production period; the “Regulations Risks” for the pre-production period and for the in-production period; and so on. The cumulative probabilities for each category can be derived by averaging the probabilities of occurrence for each macro political risk included in the category, or by applying a predetermined weighting of the individual macro political risks within the category. If multi-year cumulative probabilities are derived, then they should be translated into single-year estimates using statistical formulas, since most investment economic analysis is conducted on an annual basis. In the embodiment illustrated, multi-year cumulative macro political risk probabilities are used for ease of assessment.

Quantifying the probabilities of an occurrence of the risk event for each political macro risk requires defining threshold levels below which it is assumed the risk does not occur. Establishing the magnitude of the threshold levels takes out the arbitrary element of merely saying an increase in taxes or an increase in regulations may occur. For example, one could assign a likelihood of an economic recession as defined by a threshold level of two-percentage point reduction in the gross national product, etc. Thresholds are also a way to ensure that countries are compared in a more objective and consistent manner. For example, country A could have a 56 percent chance of a decrease in domestic demand such that the GDP (gross domestic product) drops by 2 percentage points over the next five years, this risk in country A can then be properly compared to on a consistent basis with country B which could have an 85 percent chance of a decrease in domestic demand such that the GDP drops by 2 percentage points during that same time frame.

While most businesses are very capable of generating economic forecasts for their investments, they have little or no expertise in evaluating political risks. As such, they may find the process of risk quantification overwhelming. In a preferred embodiment, the macro political risk identifications, classifications and probability assessments of a well-established risk rating services can be used as the input. Enlisting external resources can also ensure an unbiased estimate of macro political risks, and this is consistent with the general economic valuation principles of, to the extent possible, using unbiased estimates formed in the market place.

In the embodiment illustrated, Standard & Poor's “DRI-WEFA Global Risk” service (referred to as “DRI-WEFA”) is used in arriving at the multi-year cumulative probabilities for each macro political risk category. The DRI-WEFA is useful because it represents an unbiased and consistent analysis of risk. For most countries, DRI-WEFA, based on its internally defined thresholds, provides on a quarterly basis a five-year cumulative probability of the occurrence of each commonly known macro political risk. For example, DRI-WEFA's threshold definition for each macro political risk used in the illustrated embodiment (listed in Table 2) are set out in Chart 1 at the end of this description.

In the embodiment illustrated (an oil & gas investment in Russia), the DRI-WEFA probabilities for each macro political risk within a category are averaged to produce a risk probability for each category. For example, in this illustration under the “Regulations Risk” category, three macro risks are included: “Environmental Regulations Risk”, “Import Regulations Risk” and “Export Regulations Risk”. (See Table 3 below)

TABLE 3
Ways of estimating macro risk category probability based on individual component
probabilities

| Equal Weighting Example | | | Unequal Weighting Example | | |
|---|---|---|---|---|---|
| | | Cum. | | | Cum. |
| Macro Risks | Weighting | Probability | Macro Risks | Weighting | Probability |
| 1 Environmental | 33% | 50% | 1 Environmental | 50% | 50% |
| regulations risk | | | Regulations Risk | | |
| 2 Import regulations risk | 33% | 30% | 2 Import regulations risk | 25% | 30% |
| 3 Export regulations risk | 33% | 10% | 3 Export regulations risk | 25% | 10% |
| Regulations Risk | 100% | 30% | Regulations Risk | 100% | 35% |
| Category Total | | | Category Total | | |

Suppose, for example, that DRI-WEFA had assessed the “Environmental Regulations Risk” at 50% (i.e., the cumulative likelihood that more environmental regulations would be enacted over the next 5-year period is 50%), the “Import Regulations Risk” at 30% and the “Export Regulations Risk” at 10%, these would total 90% and when divided by three would produce an average of 30%. (There is a 30% cumulative likelihood that the host country will enact more regulations over the next 5 years). Alternatively, the probability could be a weighted average estimate based on a determination of the relative importance of each of those risk classifications to the project. For example, it could be determined that the “Environmental Regulations Risk” would be the most detrimental to the project of any of the three risk classifications. Thus, it might be given a 50% weighting and the “Import Regulations Risk” and “Export Regulations Risk” classification each be assigned a 25% weighting. Thus, the calculation to determine the “Regulations Risk” category probability would be “Environmental Regulations Risk”—50%×50%, “Import Regulations Risk”—25%×30%, and “Export Regulations Risk”—5%×10%, for a total weighted average likelihood of 35%.

The macro political categories can be of any desired number. Preferably, the number of categories (or risks if each categories contains only one risk classification) used in the invention is at least three and up to and including ten. This number of categories provides a balance between having a reasonable number of potential uncertainties that might impact the project being considered, while not over complicating the calculations and increasing the time required to complete the analysis. The quantification of the macro political risk categories can be performed manually or by use of a program subroutine, and the results can be inputted manually, or from the subroutine, or both.

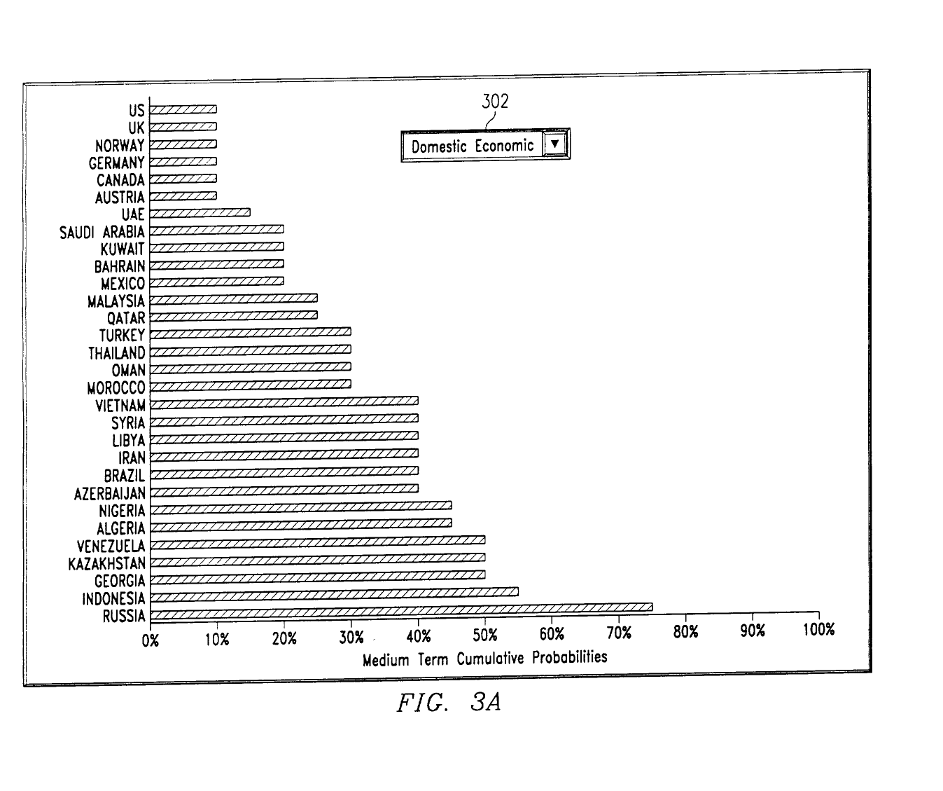

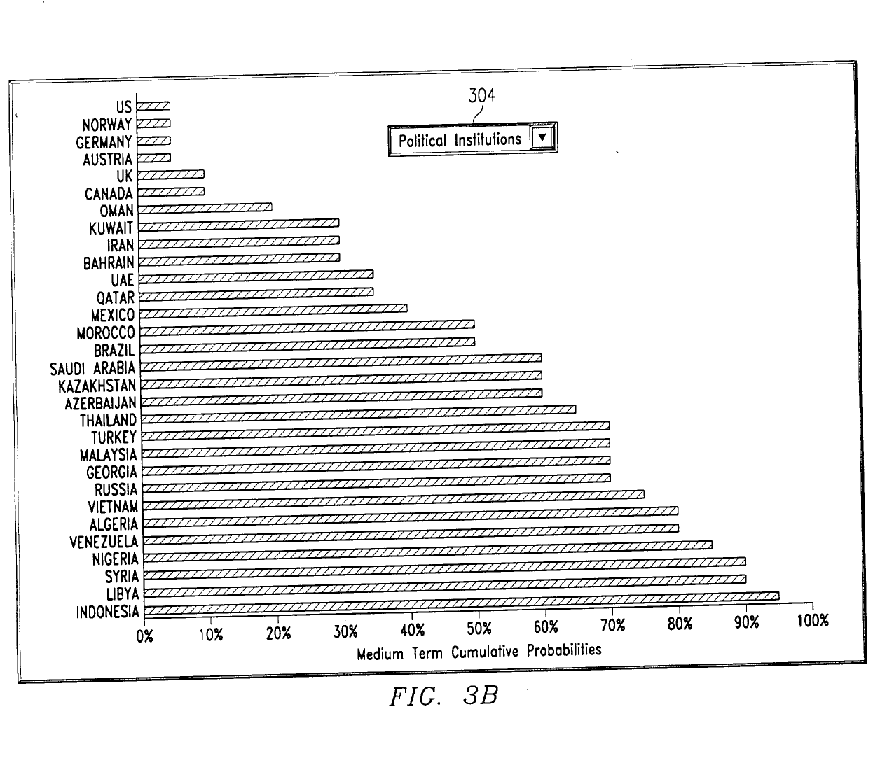

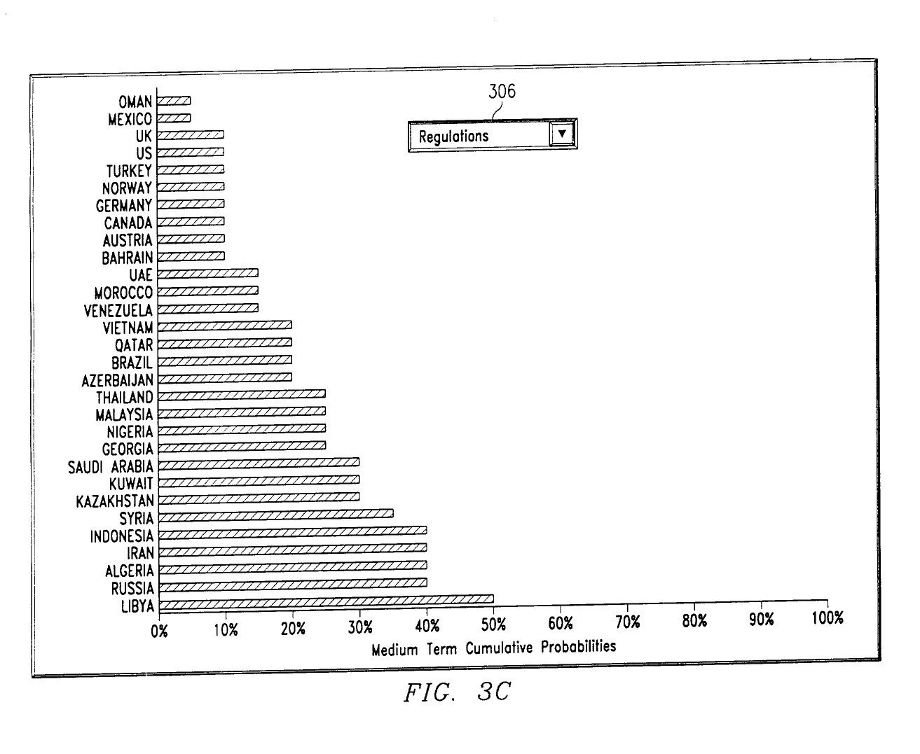

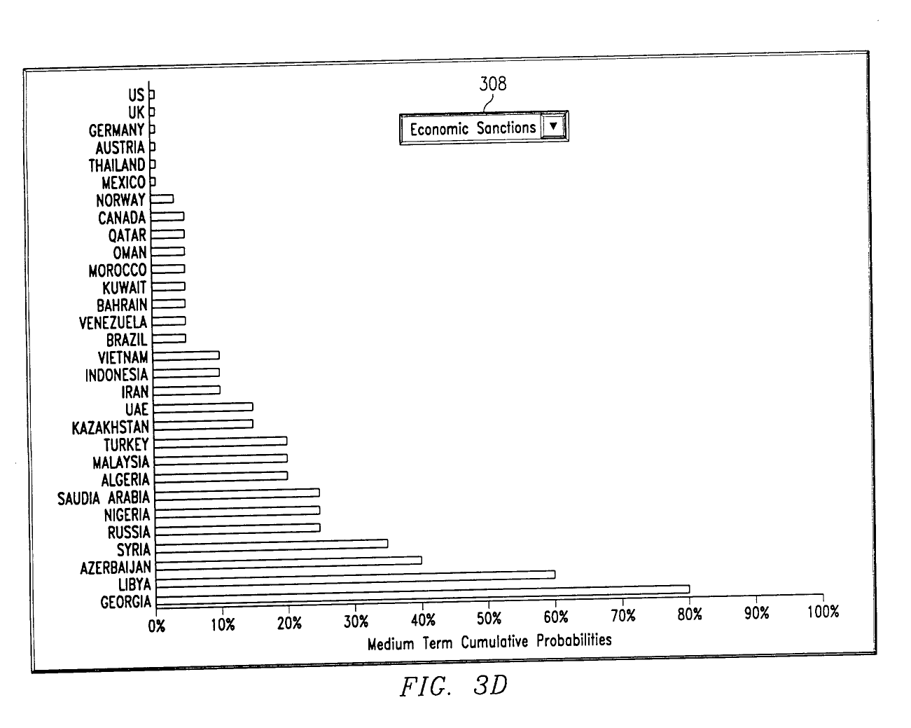

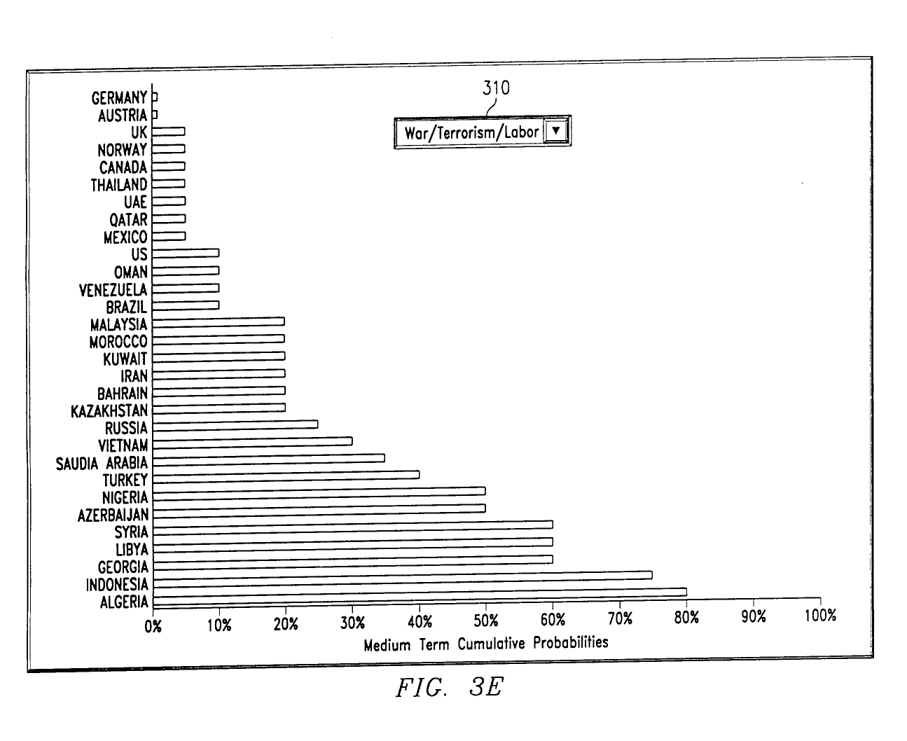

FIGS. 3A-3E illustrate the resultant cumulative probabilities for the five macro risk categories (as defined in the embodiment illustrated) for various countries over the five-year period starting from Q1, 2001: “Domestic Economic Risk” FIG. 3A—item 302, “Political Institutions Risk” FIG. 3B—item 304, “Regulations Risk” FIG. 3C—item 306, “Economic Sanctions Risk” FIG. 3D—item 308, and “War/Terrorism/Labor Risk” FIG. 3E—item 310. Similar charts can be generated for the other categories. In each of FIGS. 3A-3E, the x-axis is the probability of the risk occurring and the y-axis identifies potential countries in which projects may be contemplated.

Since the cumulative probabilities are estimated on a five-year basis (2001-2006), and more often than not, the sub-periods previously defined in block 104 are not in five-year segments, it is preferable that the five-year probabilities should be extrapolated to fit into the defined projects sub-periods, using the following statistical formula:

$$Ycum = 1 - {( 1 - Xcum )}^{\frac{Y}{X}}$$

x—numbers of years in the original period,

y—number of years in the translated period,

Xcum—the cumulative probability of the original estimate, and

Ycum—the cumulative probability of the new estimate.

In the example illustrated, this means stretching Russia's five-year (2001-2006) DRI-WEFA macro cumulative probabilities derived from DRI-WEFA data into an eight-year (2001-2008) equivalent pre-production period cumulative probabilities. (Note: in the example the pre-production period has been defined as 8 years for the illustrated project.) So for the macro political risk category—“Domestic Economic Risk” for Russia, the 5-year DRI-WEFA cumulative probability of 75% (see FIG. 3A) is translated into the equivalent 89% cumulative probability over the eight-year pre-production period using the above formula, assuming x is 5 years and y is 8 years. Table 4 below outlines the 5-year cumulative probabilities and their corresponding 8-year probabilities for the five macro political risk categories used in the embodiment illustrated (an oil and gas investment in Russia).

TABLE 4
Translating 2001-2005 DRI-WEFA cumulative probabilities into
2001-2008 cumulative ones

| | 5-year Macro | Estimated Pre- |
|---|---|---|
| | Probabilities for | Production |
| | Russia | Risk Probabilities |
| Macro Risk Category | (source: DRI) | (extrapolated) |
| Domestic Economic Risk | 75% | 89% |
| Regulations Risk | 40% | 56% |
| Economic Sanction Risk | 25% | 37% |
| Political Institutions Risk | 70% | 85% |
| War/Terrorism/Labor Risk | 25% | 37% |

The cumulative probabilities for the in-production period is not directly available since most of the commercial risk evaluation services, such as DRI-WEFA, do not provide macro probabilities beyond 5 years. Therefore, it is useful to identify proxy countries to assess long-term in-production risks. This involves identifying a country, or a basket of countries that the project country would most resemble to during that future period. In the illustrated example, the Czech Republic during the 2001-2005 period is selected to be the long-term proxy for Russia. In other words, it is assumed that the Russian political environment in the future when the production starts (or eight years from now) can be approximated by the current Czech Republic estimates. As such, the DRI-WEFA's probabilities for the Czech Republic are used as a basis to approximate project's in-production macro risks. Using the method above, the Czech's five-year (2001-2006) DRI-WEFA macro cumulative probabilities are translated or extrapolated for the 15-year in-production period (2009-2015).

TABLE 5
Translating 2001-2005 cumulative probabilities into
2009-2025 cumulative ones

| | 5-year Macro | |
|---|---|---|
| | risk | |
| | Probabilities for | In-production |
| | the Czech | Risk |
| | Republic | Probabilities |
| Macro Risk Category | (source: DRI) | (extrapolated) |
| Domestic Economic Risk | 35% | 75% |
| Regulation Risk | 20% | 49% |
| Sanction Risk | 15% | 39% |
| Political Institutions Risk | 40% | 78% |
| War/Terrorism/Labor Risk | 10% | 27% |

d. Quantifying Conditional Project Manifestation Probabilities

Project specific political risks are identified, block 114. Project specific political risks are potential risk events that are material at the project investment level and can affect the value of the project. The main distinction between macro risks and project specific political risk events is two-fold: a) the level of occurrence—the macro risks materialize at the country level, while the project specific political risk events take place at the project level, e.g, an oil and gas development project and a telecommunication project in China will be exposed to very different project specific political risks, while subjected to the same macro political risk exposures; b) the means of impact—macro risks do not impact project economics directly, but they manifest themselves in project specific risk events which then alter economic outcomes.

Project specific political risk events can be selected from historical precedents and they can be different for different types of projects (e.g., OPEC quota risk applies to oil & gas developments, feedstock risk would apply to a power plant investment). Once the list of possible project specific political risk events is compiled, it may be necessary to select the more statistically significant project specific risk events in order to simplify the analysis and speed up the assessment. It is understood that any number of project specific risks could be utilized; however, in a preferred embodiment, the project specific political risk events should be less than 20 and preferable from 5 to 10. In the illustrated embodiment of an upstream oil production project in Russia, project specific political risks which can be identified include such items as: contract approval delay, renegotiation of contracts, revocation of export permit, physical disruption of operations, confiscation of project assets, restriction on profit repatriation, shut-down of pipeline, wrongful calling of bid or performance bonds, withdrawal of licenses, currency devaluation, forced NOC (National Oil Company) participation, etc.

One then can identify, based on experience, how macro political risks are manifested in each project specific political risk event, block 114. Although each macro political risk category can tangentially affect a project specific risk event, to simplify the calculations, those which are not statistically significant are not included. In a preferred embodiment, this is determined by looking at the individual macro political risks within each macro political risk category rather than the broad categories in which the macro political risks were lumped together. For example, in the development of an oil field, the macro political risk category “Political Institutions Risk” includes the corruption risk and the bureaucracy risk which could manifest themselves by a delay in contract negotiation.

Also, the evaluation involves determining whether the project specific risk event can result from macro political risks within one category or result from macro political risks in more than one category. Table 6 outlines the association relationship between macro political risk categories and project specific political risk events for the illustrated example. For example, the project specific risk event—“Fiscal/Tax regime approval/negotiation delay” is only attributable to those risks within the “Political Institutions” category. In contrast, the project specific risk event—“withdrawal/breach of legal rights vital to an upstream oil project license” would be affected by risk within the “Regulation” category and the “Political Institutions” category. While it is also possible to find a project specific political risk events impacted by several macro political risks simultaneously, in a preferred embodiment, each project specific political risk event should be limited to the impact of three or less macro risks for simplicity and ease of calculation.

TABLE 6
The causal relationship between macro political risk categories and project specific
risk events for an upstream oil and gas investment

| Macro Risk Category | Associated Project Specific Risk Events |
|---|---|
| Domestic Economic Policy | Contract/Fiscal Terms Modified/Renegotiated |
| | Transportation/Pipeline Routing Agreement Modified/Renegotiated |
| | 10% or more change in transportation/Pipeline Tariff Agreement |
| | Confiscation of project assets & bank accounts |
| | Flow of funds/FX restrictions: dividends, royalties, interest payments |
| | 10% or more changes in tax codes; capita gains, corporate, other taxes |
| | (i.e., 30%-33%) |
| | 25% or more in real Currency Devaluation vs. US$ |
| | NOC Participation |
| | Privatization/Nationalization of partners, suppliers or offtakers |
| Regulation | Contract/Fiscal Terms Modified/Renegotiated |
| | Withdraw al/breach of legal rights vital to the Upstream project |
| | (licenses, export permit, PSA, etc.) |
| | Transportation/Pipeline Routing Agreement Modified/Renegotiated |
| | 10% or more change in transportation/Pipeline Tariff Agreement |
| | NOC Participation |
| | Privatization/Nationalization of partners, suppliers or offtakers |
| Economic Sanctions | Physical disruption of Upstream or Midstream Operations lasting 6 |
| | months or more |
| | Confiscation of project assets & bank accounts |
| Political Institutions | Fiscal/Tax Regime approval/negotiation delay (2008+) |
| | Withdraw al/breach of legal rights vital to the Upstream project |
| | (licenses, export permit, PSA, etc.) |
| | OPEC Quota Risk |
| War/Terrorism/Labor | Physical disruption of Upstream or Midstream Operations lasting 6 |
| | months or more |

Once the relationships are established, the associated conditional probabilities of the project manifestations are quantified and inputted, block 116. The input means for the quantification can be a user interface, or by data link/interface with a subroutine or program which aids in determining the quantification. For example, the quantification can be accomplished by formulating questions which relate the project specific political risk events to the macro political risk categories or components of the category. From these questions, a conditional risk probability can be derived for the project manifestation. In a preferred embodiment, the various responses to the question can be fed into a multi-variant scoring system with predefined decision hierarchy and weighting. These decision hierarchy and weightings are based on past projects, and ongoing experience during the life of projects. This standardized approach is preferred because a) it provides a greater degree of consistency than results from allowing different individuals to make “educated guesses” as to what each conditional probabilities should be; b) it results in more thoughtful evaluation of the risk and affords the users a method of self-education; c) and it captures the knowledge of other investments political risk assessments since the multi-variant decision hierarchy scoring system will be continuously updated and calibrated against other investments to achieve consistency from project to project and from country to country.

Table 7 demonstrates an approach for quantifying conditional project manifestation probabilities and their respective multi-variant scoring systems for an upstream oil & gas exploration and production project. The entire “expert system” can be found in Charts 2-8 below. For purposes of illustration, the answer for an assumed project are in bold italics.

TABLE 7
Sample Conditional Project Manifestation Probabilities Quantification

| Macro Risk Category | | | | Domestic Economic | |
|---|---|---|---|---|---|
| Project Specific Risk Event | | | | Fiscal Regime Modified/ | |
| | Sectional | Sectional | | Renegotiated | |
| | Weightings | Score | Questions | Available Answers | Scores |
| 1 | 20% | 10 | Any unilateral fiscal regime | Devastating | 100 |
| | | | changes in the last 20 years? | [symbol] | [symbol] |
| | | | | Some | 10 |
| | | | | Little | 5 |
| | | | | No | 0 |
| 2 | 15% | 6.75 | Is fiscal regime regressive or | Very Regressive | 0 |
| | | | progressive? | Regressive | 15 |
| | | | | Don't Know | 30 |
| | | | | [symbol] | [symbol] |
| | | | | Very Progressive | 60 |
| 3 | 20% | 10 | Economy/Export's dependency | [symbol] | [symbol] |
| | | | on oil revenue? | High | 40 |
| | | | | Average | 20 |
| | | | | Low | 10 |
| | | | | Very Low | 0 |
| 4 | 15% | 12 | Support of the project at all | Very Strong | 0 |
| | | | levels of the government? | Strong | 10 |
| | | | | Average | 25 |
| | | | | Weak | 50 |
| | | | | [symbol] | [symbol] |
| 5 | 10% | 6 | Is petroleum legislation in the | Yes | 0 |
| | | | country well established? | Don't Know | 25 |
| | | | | [symbol] | [symbol] |
| 6 | 5% | 0 | Are there any “stability” | [symbol] | [symbol] |
| | | | provisions in the contract? | Don't Know | 25 |
| | | | | No | 50 |
| 7 | 5% | 2.5 | If ans. is “yes” to the above | Yes | 0 |
| | | | question, is it enforceable? | Don't Know | 25 |
| | | | | [symbol] | [symbol] |
| 8 | 5% | 0 | Does the partnership/financing | Certain | −80 |
| | | | structure alleviate risk? | High | −30 |
| | | | | Toss | 0 |
| | | | | Moderate | 0 |
| | | | | Negligible | 0 |
| | | | | [symbol] | [symbol] |
| Sum | 100% | 47.25 | | | |

Assuming the answers to each question are in bold italics, the weighted average is 47.25. The conditional probability is derived as follows:

47.25=50×20%+45×15%+50×20%+80×15%+60×10%+50×5%

This can be interpreted that there is a 47.25% likelihood that the existing contract (or the contract assumed in the baseline model) will be subject to renegotiation in the event of domestic economic failure over the pre-production period. Of course, if desired, this evaluation can be repeated with of a number of experienced personnel. Their respective answers can be averaged to determine the final conditional probability.

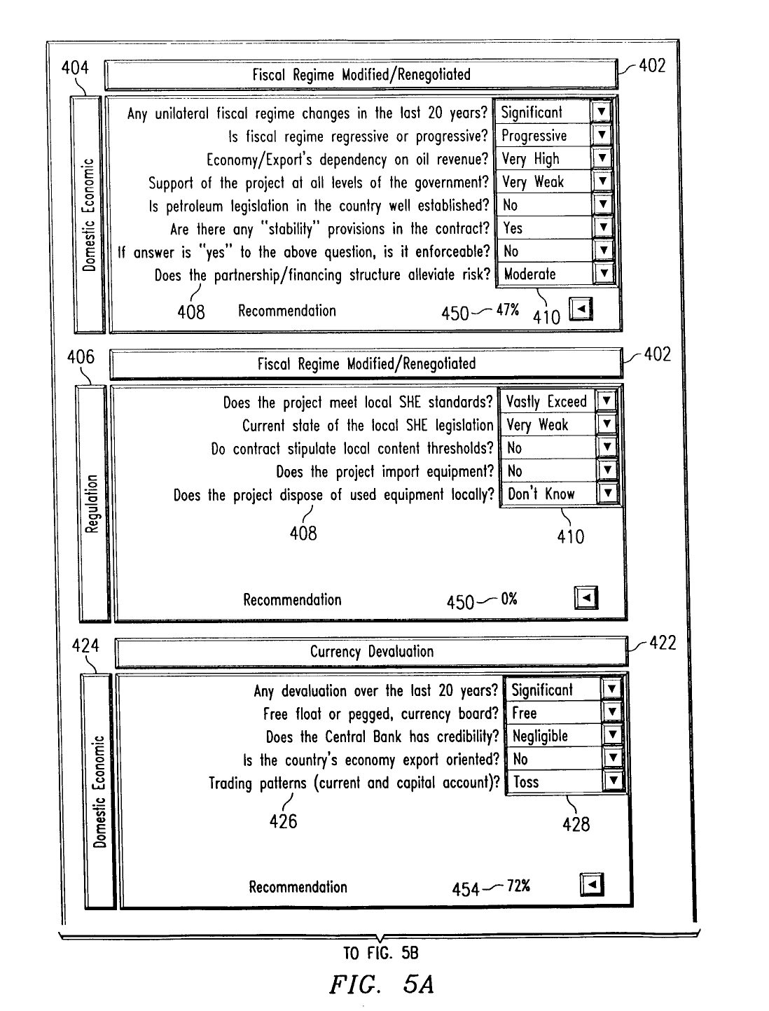

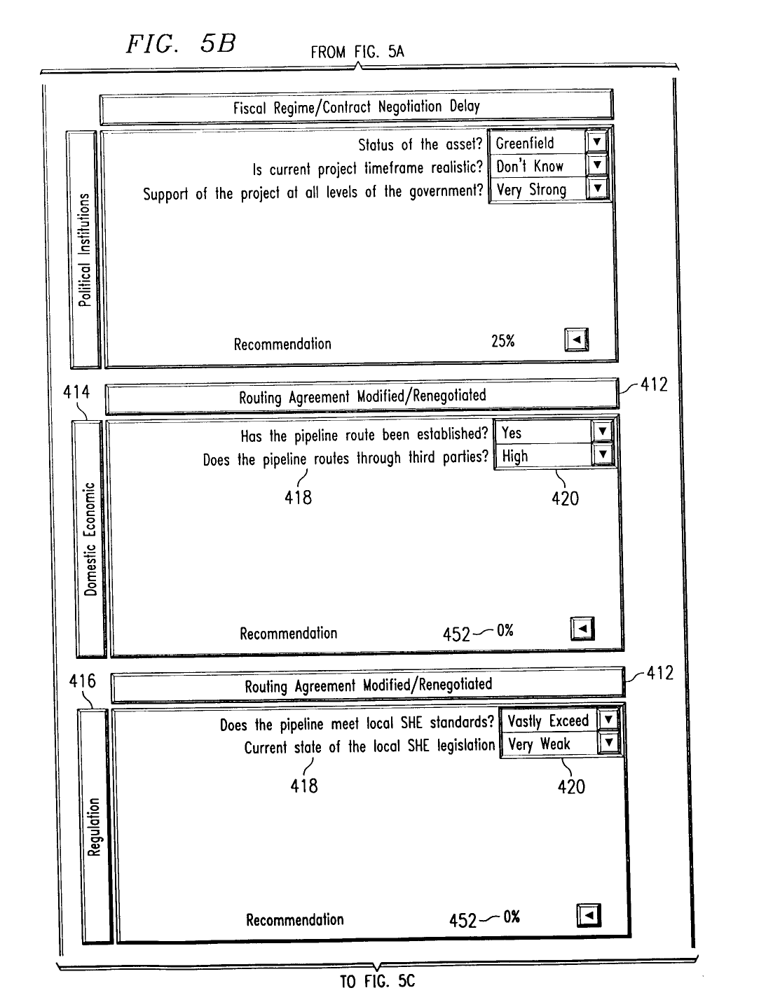

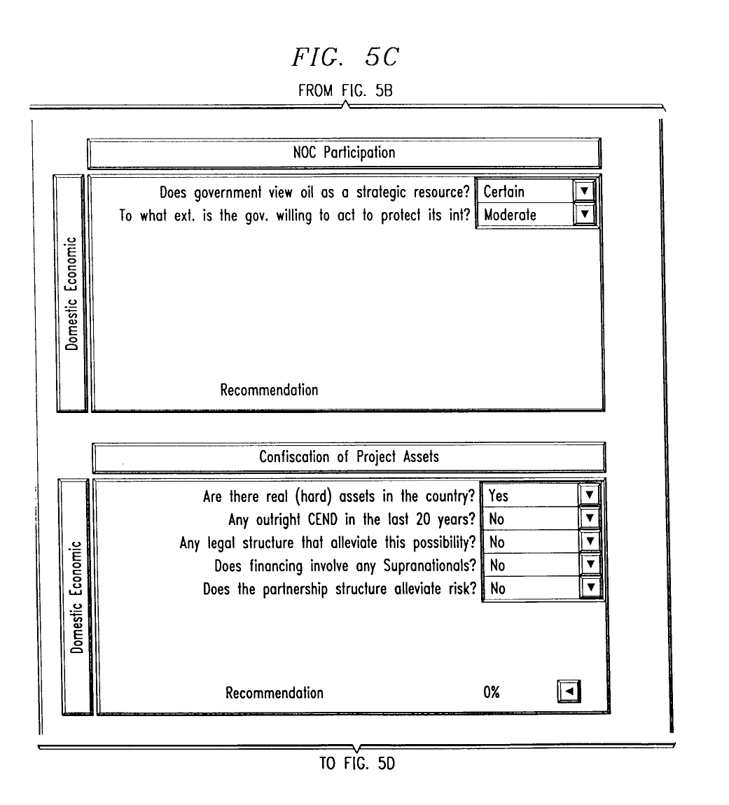

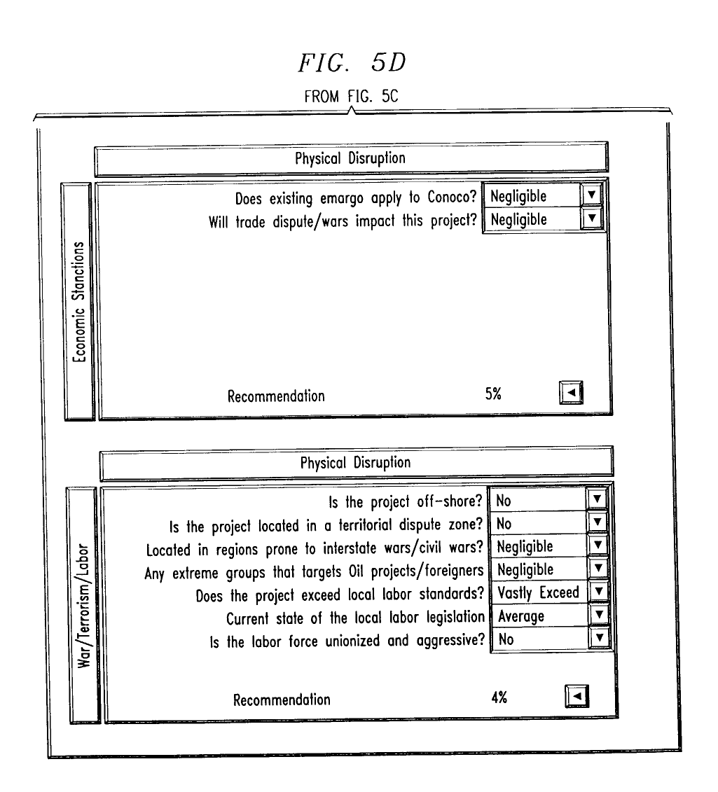

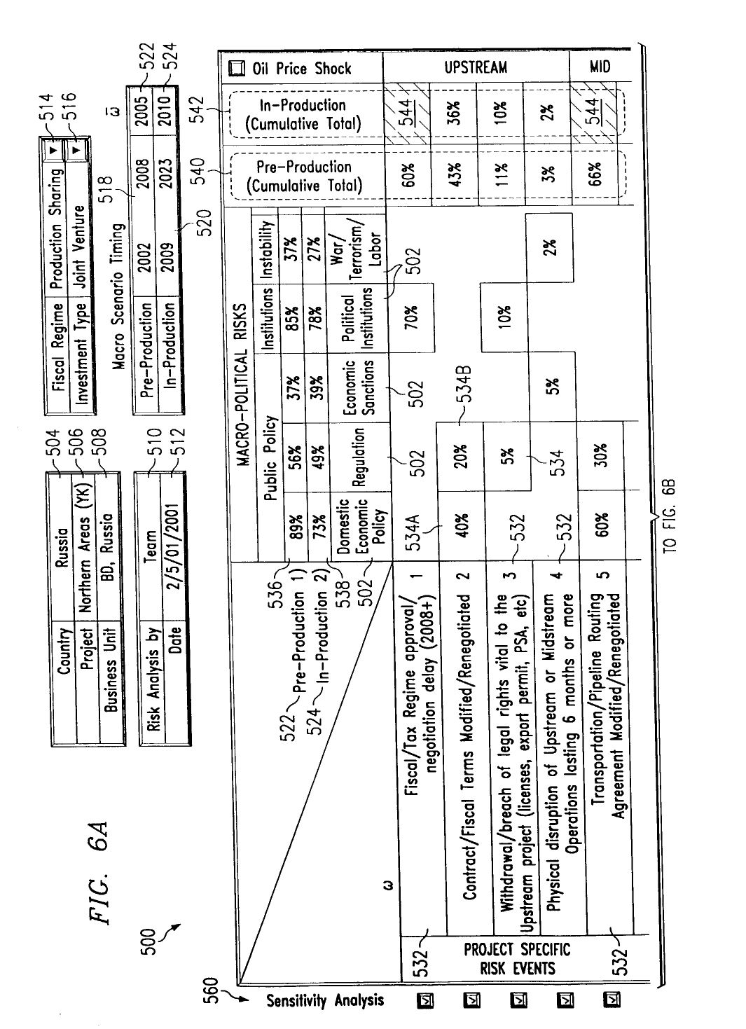

FIGS. 5A-5D illustrate input screens for worksheet to quantify the conditional probabilities of various project manifestation for one embodiment of the invention. For example, the project specific risk event—“Fiscal Regime Modified/Renegotiation”, item 402, which was previously defined as impacted by the macro political risk categories of Domestic Economic Risk”, item 404, and “Regulation Risk”, item 406, is quantified in the top two boxes in FIG. 5A. Relevant questions to determine the quantification are presented to the user, item 408, and the user selects a response to the questions, item 410. The system will then process the responses in accordance with a predetermined algorithm (such as the example set out above) and produces a recommended conditional risk probability for the project manifestation which users can overwrite should they choose to do so, items 450. The bottom box in FIG. 5A quantifies the “Currency Devaluation” project political risk event, item 422, which is only effected by the related “Domestic Economic” macro political risk, item 424, and again appropriate questions are presented, item 426, and the user selects appropriate responses, item 428. The recommended conditional risk probability for each project political risk event is then determined, item 454. A similar worksheet is displayed for the project risk event—“Routing Agreement Modified/Renegotiated”, item 412, which is impacted by the macro political risk category of “Domestic Economic Risk”, item 414 and “Regulations Risk”, item 416. Again relevant questions are presented, item 418, and the user inputs appropriate responses, item 420. The recommended conditional risk probability is then determined, item 452. These are sample questions that have been useful in evaluating the risks. Other questions can be employed for an upstream oil project or other questions may be appropriate for other types of projects.

e. Determining and Reassessing Project Risk Event Probabilities

With the probabilities of all macro political risk categories and their respective conditional probabilities of project manifestations quantified, it is possible to calculate the aggregate probabilities of the occurrence of each of the project specific political risk events, block 118. The illustrated embodiment will help clarify this step.

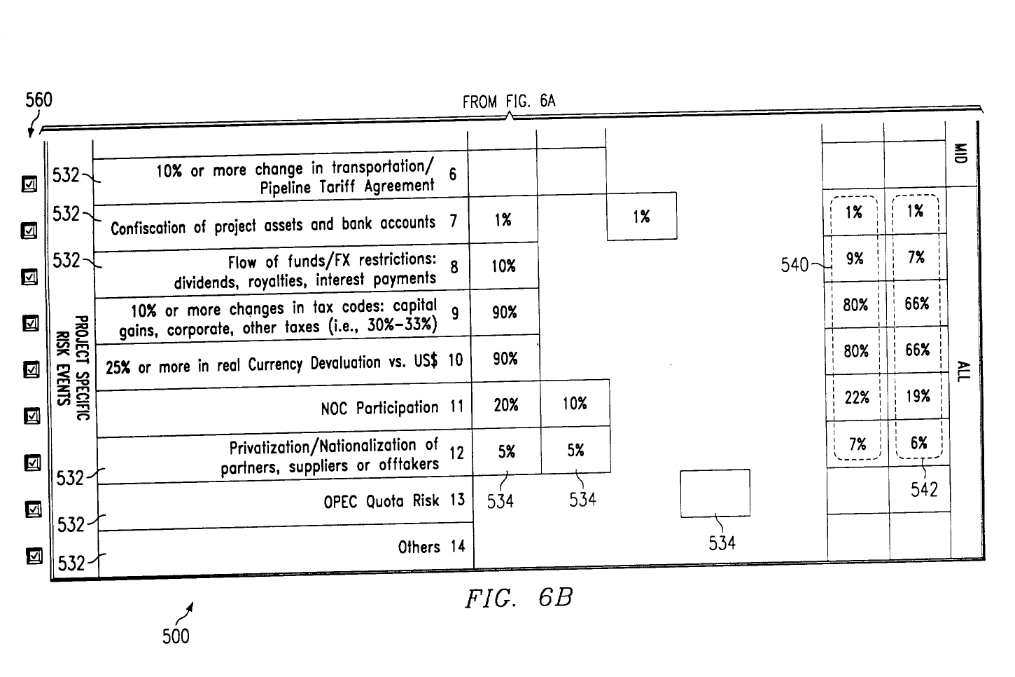

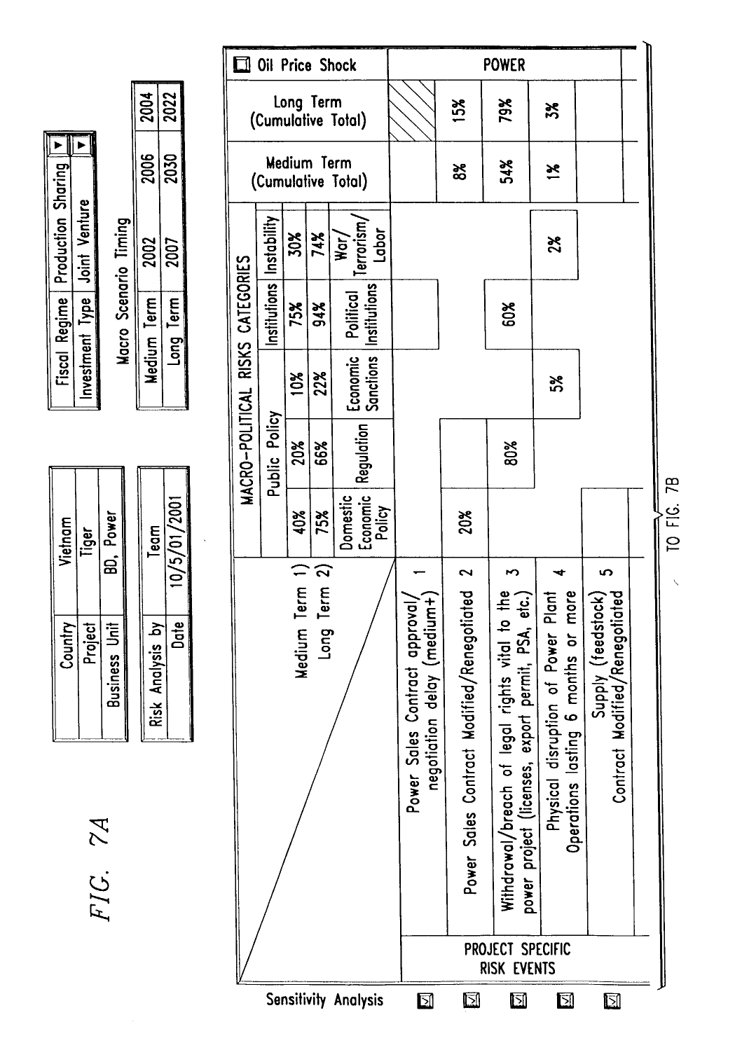

FIGS. 6A and 6B is an illustration of an input worksheet 500 for the illustrated embodiment, an upstream oil and gas development investment in Russia. The sheet 500 contains areas to input some background of the project being considered, such as: country of investment, cell 504, project name, cell 506, business unit, cell 508, identity of the person performing the analysis, cell 510, the date of the analysis, cell 512, type of fiscal regime under which this project is governed, cell 514, type of investment, cell 516. Other information can be requested and inputted. This information is helpful for administration purposes.

The expected life span of the illustrated project is divided into two sub-periods: the pre-production period and the in-production period, the time boundaries for these sub-periods are inputted in cell 518 and cell 520 respectively (this data is used to apportion the multi-year cumulative probabilities into single year estimates). The five macro political risk categories are shown in line 502. The macro political risks categories quantifications are inputted for each of the sub-periods respectively in line 536 and line 538. For example, the “Domestic Economic Risk” category for the pre-production period has a probability of 89% (i.e., there is an 89% cumulative probability that one of the events under domestic policy category will materialize over the eight-year pre-production period and that probability is 73% for the 15-year in-production period). The detailed discussion of a method to develop these values can be found in the discussion relating to block 110 FIG. 2A. Other methods can also be used. The input screen also lists the project specific political risk events in column 532. The conditional probabilities for each project manifestation are inputted in the boxes cells 534 (only four boxes are labeled to avoid excessive marking on the figure). These conditional probabilities can be estimated using a multi-variant decision hierarchy scoring system as discussed in detail in reference to block 116. FIG. 2A. For example, the 40% in box 534A indicates that if one of the risks in the “Domestic Economic Risk” category materializes (e.g., given a deterioration in domestic economics in the amount of a 2 percentage drop in GDP), there is a 40% chance that the project's contract terms will be renegotiated. By the same token, the 20% in box 534B indicates that if one of the risks in the “Regulation Risk” category materializes, there is a 20% chance that the project's contract terms will be renegotiated. The existence of boxes indicates that project specific political risk events are related to one or more of the macro political risk categories. Where there is no input box adjacent to the project specific political risk events, it indicates a determination that the project specific political risk events is either not impacted by that macro political risk or that the impact is negligible and can be disregarded. For example, while the project specific political risk event—“Physical disruption of upstream and mid-stream operation lasting 6-months or longer” can be caused by risks in the “Economic Sanction” or in the “War/Terrorism/Labor” category, it is unlikely that it can be caused by the other three macro risk categories. Some project specific political risk events may not be applicable to every country under consideration, such as the “OPEC quota risk”, but are important for comparing projects between OPEC and non-OPEC countries. In the illustrated embodiment, it is decided that a project political risk cannot be driven by more than two macro risk categories for each of calculation. This is evident in this worksheet: there is no more than two input boxes for each project risk event. Other projects may define more macro drivers if the user so chooses.

The conditional project manifestation probabilities are then combined with the cumulative probabilities for each macro political risk category of each sub-period to derive the aggregate cumulative probabilities of each project specific political risk event for each sub-period, in column 540 and column 542 respectively. For example, in the illustrated embodiment, the cumulative probability for the project specific political risk event—“Fiscal Regime/Contract Terms renegotiated” for the pre-production period is derived as shown in Table 8 as follows:

TABLE 8
Sample calculation of aggregate probabilities of project event risks

| Cumulative Macro | Domestic 89% | Regulation 56% |
|---|---|---|
| Category Risk | | |
| Probabilities | | |
| Conditional Project | Contract Renegotiation | Contract Renegotiation |
| Manifestation | 40% | 20% |
| Probabilities | | |
| Resultant project | Probability of contract | Probability of contract |
| event risk | renegotiation resulting | renegotiation resulting |
| probabilities | from a “Domestic | from changes in |
| | Economic” failure is: | Regulation is: |
| | 89% × 40% = 36% | 56% × 20% = 11% |

Thus:

$$Total combined probability = Probability of Renegotiation results {from }^{″} Domestic Economic {failure}^{″} + ( 1 - Probability of Renegotiation result {from }^{″} Domestic {Economic}^{″} failure ) \times Probability of Renegotiation results from changes in Regulation = 36 \% + ( 1 - 36 \% ) \times 11 \% = 43 \%$$

In other words, there is a cumulative 43% likelihood that the contract will be renegotiated before production starts. In the illustrated example, macro political risk categories are assumed to be independent for ease of calculation. Other statistical calculations can be used if the macro political risk categories are assumed to be correlated.

In the illustrated embodiment, the macro political risk and the project specific political risk events are related to the projected time frames in which the manifestations would be applicable. Thus, in an oil field development project, domestic sales quotas, or OPEC quotas would not be at risk during the drilling of wells in the field but only after production from the field begins. By the same token, there are no cumulative totals for the in-production sub-period for “Fiscal/tax regime approval delay” and “Transportation pipeline rerouting” because these are not applicable in this situation, and hence blacken out on the worksheet, cells 544.

The aggregate project specific event risk probabilities should then be re-evaluated to see whether they are reasonable, block 120 of FIGS. 2A-2B. The steps discussed in relation to blocks 106-120 of FIGS. 2A-B should be re-performed and adjustments made, if any, until one is fully satisfied with the results, block 122 of FIGS. 2A-B.

f. Allocating Multi-Year Cumulative Probabilities Into Single Year Estimates

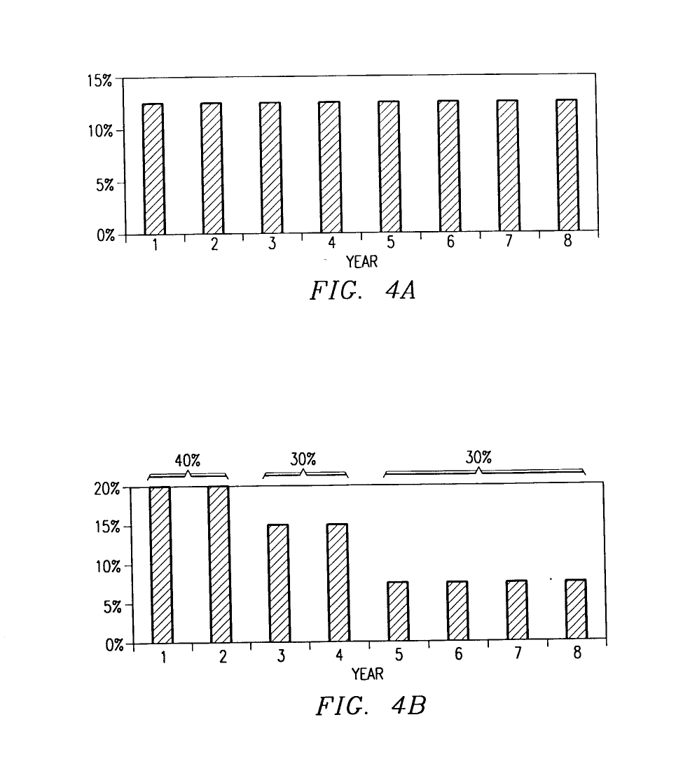

If multi-year cumulative probabilities are used as in the illustrated embodiment, the system can include a timing distribution which apportions the multi-year cumulative probabilities into annual probabilities for simulation, block 124. This is usually done by evaluating the possible timing of macro political risk events. For example: if we know there is a 50% likelihood that there will be a recession over the next 5 years, what is the likelihood that there will be a recession during the first year, the second year, the third year, the fourth year or the fifth year. If the project owner has no specific forecast on which year the recession will arrive, one can assume that the risk of recession happening to be equal throughout the time period selected. Now if the project owner has a strong sense that recession will arrive sooner than later, the risks can be apportioned such that in early years of that period the likelihood of the event occurring is given greater weight. In the embodiment illustrated, both approaches are used. FIGS. 4A and 4B illustrate respectively each of these examples for an eight-year period. In FIG. 4A, no specific knowledge of the risk profile is assumed, so the probabilities of an occurrence is evenly distributed. In FIG. 4B, specific knowledge is assumed indicating recession would be sooner than later; thus, the probabilities of an occurrence are front-end weighted. FIGS. 4A and 4B are for purposes of illustration, and the allocation of risk based upon likely timing can be one of any predetermined discrete distributions. However, consistency in applying timing allocation is important. Projects within similar countries should have similar timing allocations applied so as to not skew the analysis when comparing potential investments in the various countries.

The years displayed in cell 522 and cell 524 are randomly drawn from the timing distribution previously defined in block 112. FIG. 2A. For the one iteration shown, the year of trigger during the pre-production period is 2005, cell 522, and the year of trigger during the in-production period is 2010, cell 524. These numbers will be re-drawn for each iteration of the simulation. If the timing distribution in block 112 is weighed evenly (as in FIG. 4A), and assuming an 800-run Monte Carlo analysis is conducted, years in the pre-production period (2001, 2002, 2003, 2004, 2005, 2006, 2007, and 2008) will occur approximately 100 instances (12.5%) each in cell 522. If the timing distribution in block 112 is front-end loaded (as in FIG. 4B), and again assuming an 800-run Monte Carlo analysis is conducted, there will be 160 instances (20%) where cell 522 is 2001 and 2002, 120 instances (15%) of 2003 and 2004, 60 instances (7.5%) of 2004, 2005, 2006, 2007, and 2008. In the simulation of the illustrated embodiment, the trigger years signify the year of the occurrence for various risk events which may impact the value of economic parameters for that year and years thereafter.

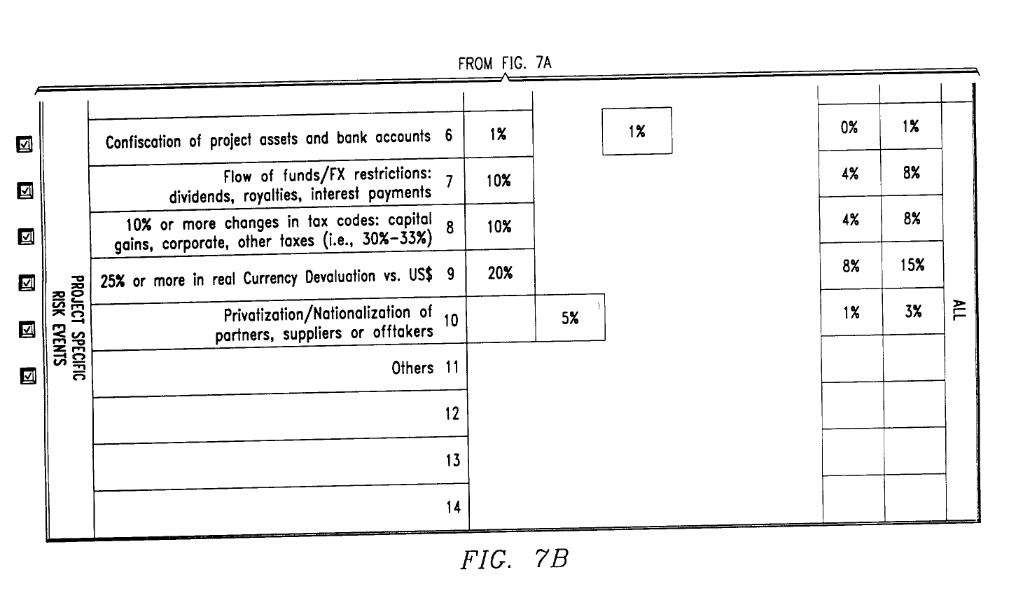

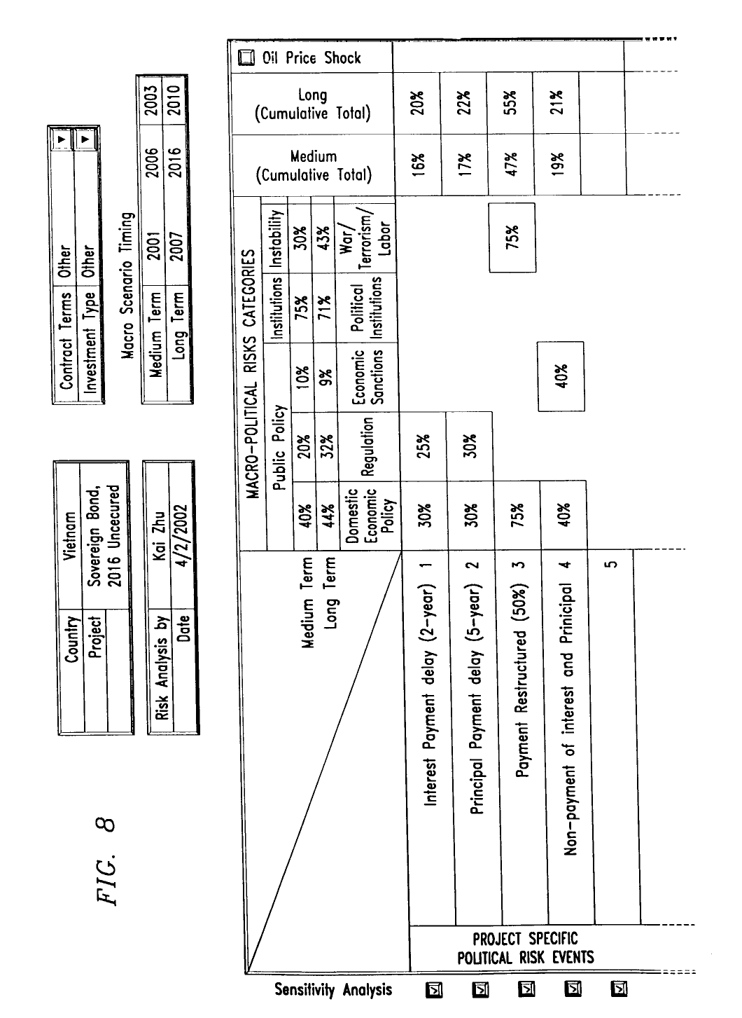

As of this point, all risk events that might have impact on project economics are identified and quantified. This method of quantifying risks can be adapted to and customized to all types of investment. FIGS. 7A-7B is an input worksheet for an electricity/power generation plant investment, and FIG. 8 is an input worksheet for a financial investment in bonds. They all use the same macro risk definitions with project specific risk events relevant to the particular project. FIGS. 7A-7B and 8 are read in a similar manner as FIGS. 6A-B, and further discussion is not presented in the interest of brevity.

g. Defining Impacts on Project Economic Parameters

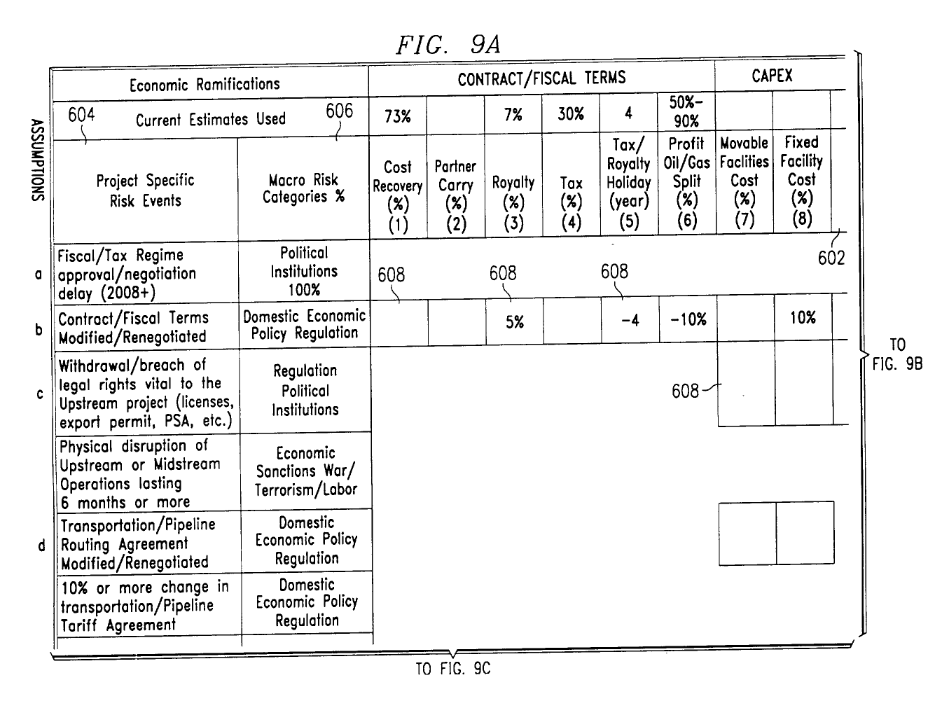

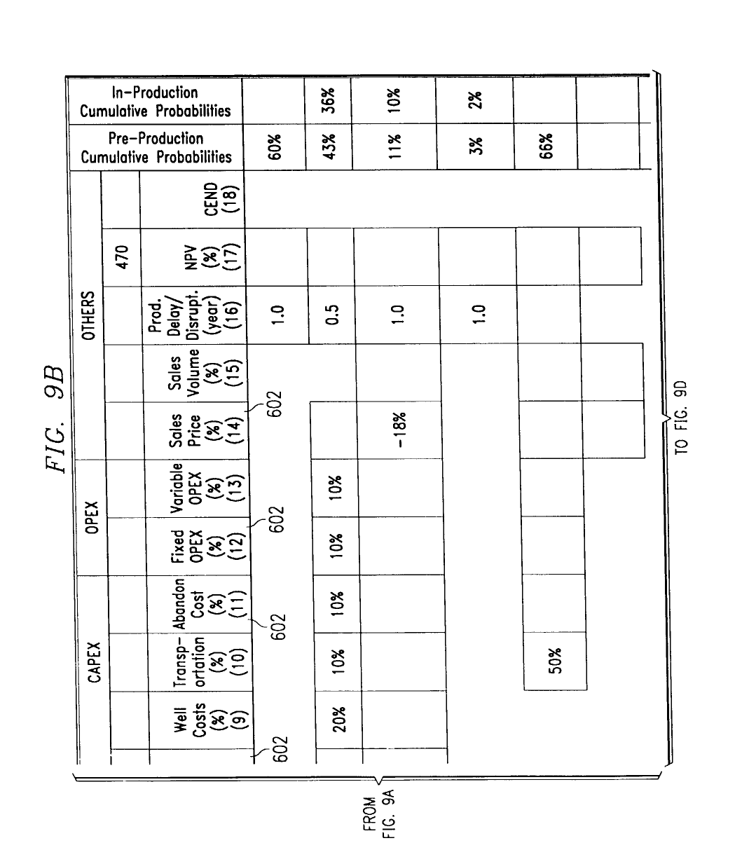

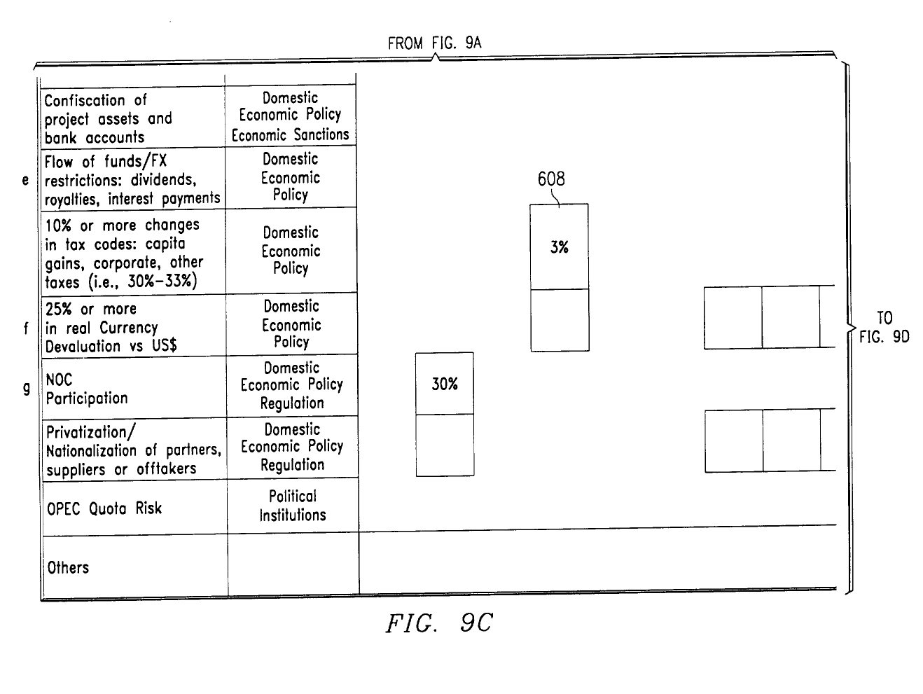

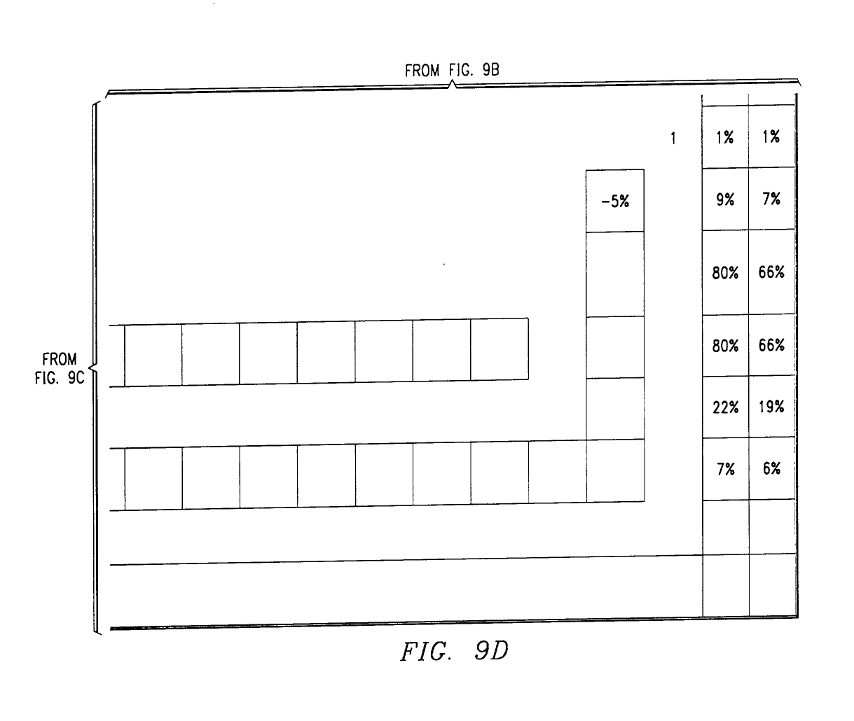

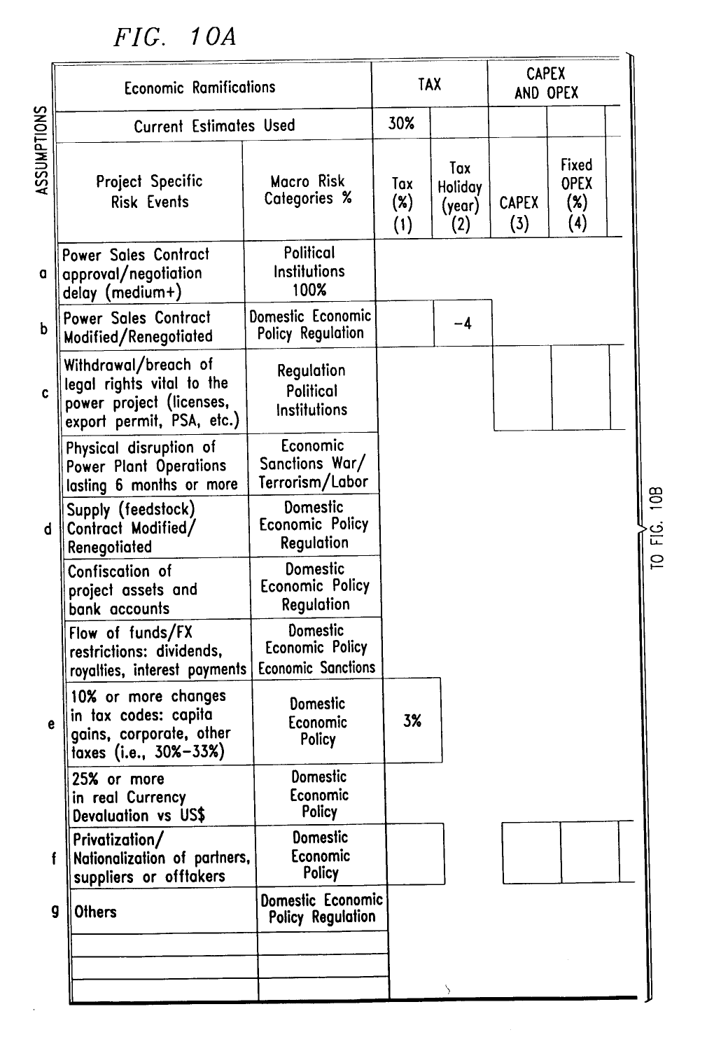

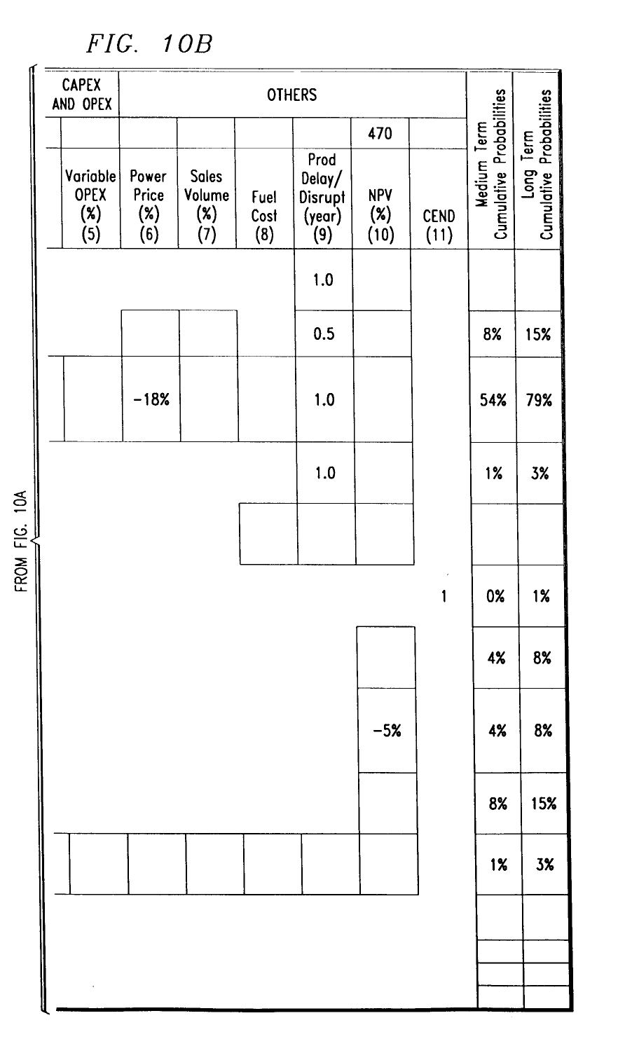

The project economic parameters that are susceptible to political uncertainties are identified, block 126 of FIGS. 2A-2B. These project economic parameters are those parameters (e.g., amount and timing of costs, revenues, growth rates, corporate tax rates and other data) commonly used to forecast the cash flows of an investment and the potential return of the investment. The project economic parameters then are assigned to each project specific political risk event, block 128 of FIGS. 2A-B. FIGS. 9A-D is an input worksheet that quantifies the economic ramifications of various parameters for the illustrated embodiment (an upstream oil & gas project) of FIG. 6. FIG. 10A and B are illustrative of input sheets for a power plant investment project. Referring to FIGS. 9A-D, the project economic parameters at risk are listed in line 602 (only several labeled for clarity). They are: cost recovery rate (as a percentage of revenue), partner carry rate (as a percentage of equity investment), royalty rate (as a percentage of revenue), tax rate, tax/royalty holiday (number of years), profit oil/gas split (as a percentage of total profit oil), various CAPEX (capital expenditures), OPEX (operating expenditures), crude oil price, production volume, etc. The project specific political risk events are listed in column 604 and the associated macro risk categories are listed in column 606. In the oil and gas example, the relationship between project economic parameters and project specific political risk events can be found in the input cells 608 (only several labeled for clarity). The existence of more than one input box indicates that the project economic parameter is related to one or more of the project specific political event risk. Where there is no input box adjacent to the project specific risk event, it indicates a determination that the project economic parameter is either not impacted by that project specific political event risk or that the impact is negligible and can be disregarded. For example, a change in tax rate would be triggered when a contract is renegotiated, but is not likely to be triggered by a delay in negotiations or physical disruption.

Users have to quantify the magnitude of impact to each economic parameter resulting from political uncertainties, block 130. Users input the impact values, which can be discrete numbers or statistical distributions (e.g., triangular distributions, typical bell-shaped distributions or other distribution profiles), into cells 608 for each of the project risk events. An example of discrete impact quantification would be, an occurrence of a project risk event—“Fiscal/tax regime renegotiated” would result in a 5-percentage point increase in the royalty rate (in the land owner's favor). An example of a triangular distribution impact quantification would be, the occurrence of the project risk event could result in an increase in the royalty rate, and the increase would be at least 2 percentage points but no more than 10 percentage points, with a most likely value of 5 percentage points.

These changes to project economic parameters will have economic impact on project values. Assume the initial royalty rate paid to the land owner is 7% (of the gross revenue) and the annual total projected gross revenue is $100 per year, then the net revenue available to investor would be $93 per year. For a four-year project, the total unrisked revenue (without accounting for the time of money value) would be $372. Now assume that a risk event occurs in the second year of the contract causing the royalty rate to increase by 5 percentage points to 12% and then to 17% following the occurrence of another event in the fourth year. The total project revenue decreases to $352 as illustrated in Table 9. Similar calculations are performed for the other economic parameters by the method and system of this invention.

TABLE 9
Illustration of how one parameter is risked for one Monte Carlo iteration

| Iteration #107 of | | | | |
|---|---|---|---|---|
| 3,000 | | | | |
| Year | 2001 | 2002 | 2003 | 2004 |
| Gross Revenue | $100 | $100 | $100 | $100 |
| Unrisked Royalty Rate | 7% | 7% | 7% | 7% |
| Unrisked Net Revenue | $93 | $93 | $93 | $93 |
| Risked Royalty Rate | 7% | 12% | 12% | 17% |
| Risked Net Revenue | $93 | $88 | $88 | $83 |

Total unrisked gross revenue = $93 × 4 = $372
Total risked net revenue = $93 + $88 + $88 + $83 = $352

h. Linking the Simulation Module to the Economic Model

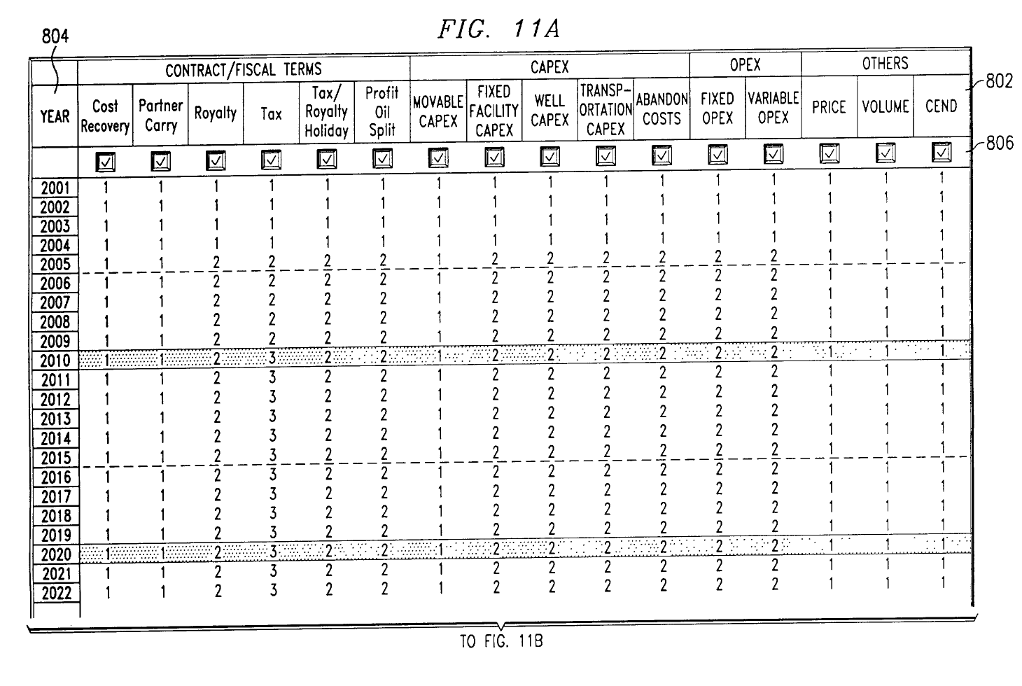

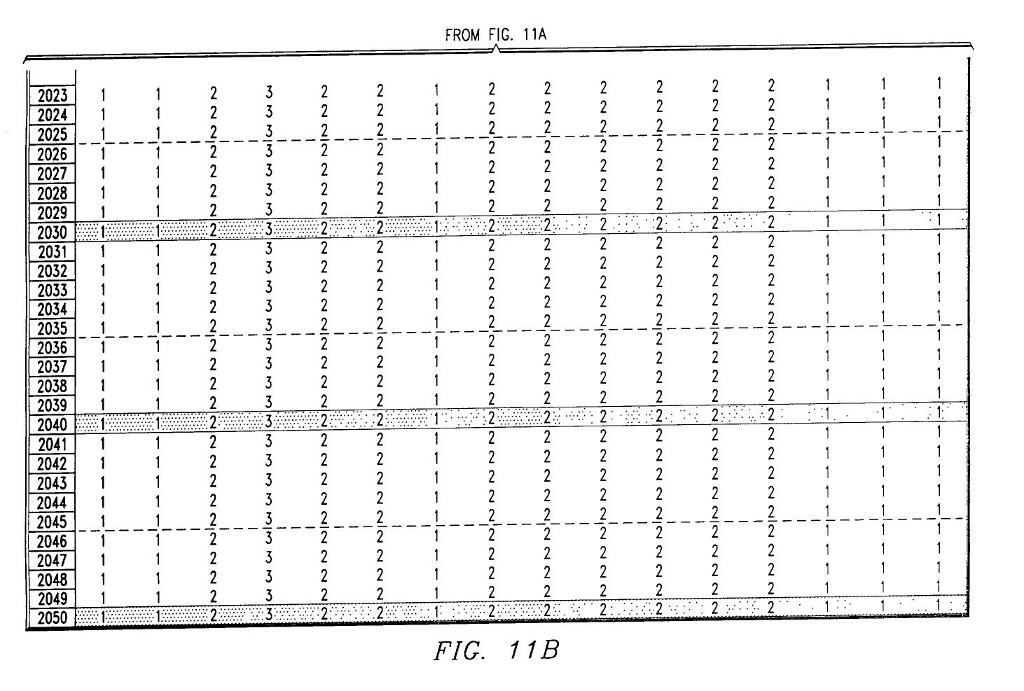

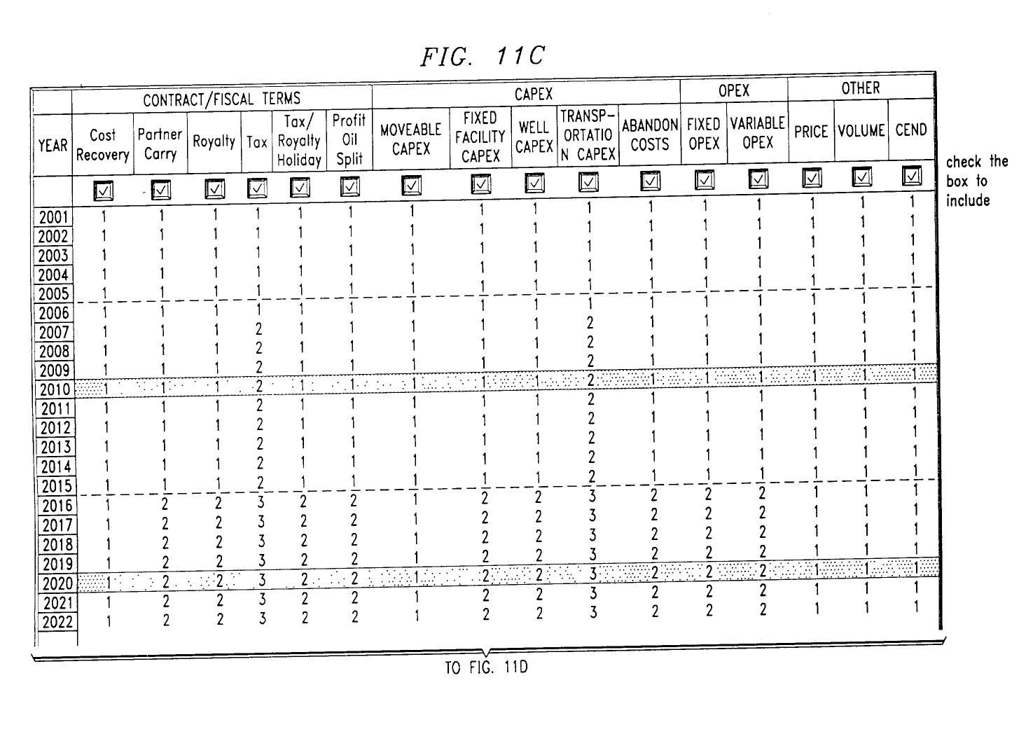

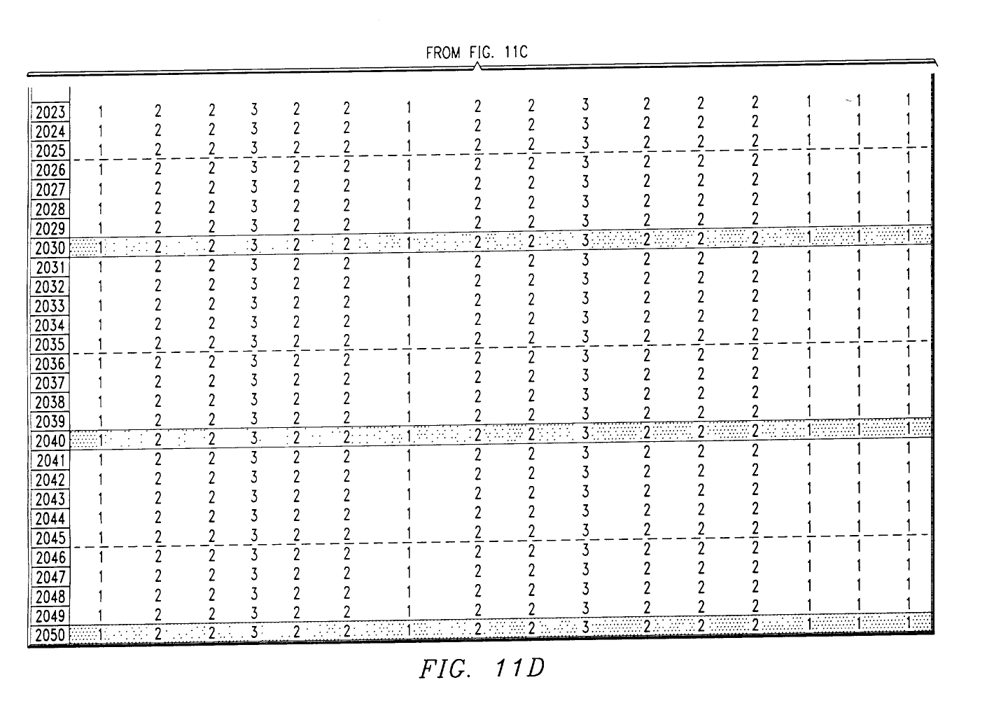

At this point, all inputs that are necessary for a probabilistic Monte Carlo simulation are collected. The various political events that may impact investment value are identified with their probabilities of occurrence quantified. The changes to the economic parameters (the effects in the economic parameters) are also quantified. Before the simulation can start, a dynamic data link needs to be established to feed the various simulated political outcomes and the resultant changes in project economic parameters to the baseline (unrisked) economic model, block 132. FIGS. 11A-11D show intermediate outputs of this invention (customized for oil and gas investment), which is used to link the changes in project economic parameters by year to the baseline economic model on a dynamic basis. The numbers set out in FIGS. 11A-11B represents one iteration of a Monte Carlo Run and the numbers set out in FIGS. 11C-11D represents another iteration. Along line 802 are the project economic parameters (the same as line 602 in FIGS. 9A-9D). The economic parameter “CEND” is an abbreviation for “confiscation, expropriation, nationalization, and deprivation”. The column 804 lists the years for which computations were preformed. The output is in the form of a 50×18 matrix of flags in the form of ones, twos, and threes. A “one” indicates no change to the project economic parameter for the corresponding year. A “two” indicates that a project political risk event that could have economic impact on the particular economic parameter has occurred, therefore changing the project economic parameter for the corresponding year and all years thereafter. A “three” indicates that a project political risk which could have economic impact on the particular economic parameter has occurred for a second time during the project life, thus changing the project economic parameter once again. Please note the flag switch—when a “one” switches to a “two” and a “two” switches to a “three”—can only take place during the trigger years (one each for the pre-production and in-production period). For this iteration, the trigger years are randomly picked to be “2005” for the pre-production period and “2010” for the in-production period. (The details on how trigger years are selected for each iteration are explained above.) Since only two sub-period periods (pre-production and in-production) have been defined for the illustrated embodiment, the largest possible number that a flag can take on is “three”. (suppose, if n sub-periods are defined, then the highest number of flags is n+1.) The four-year project example in Table 9 will be used to help clarify how flags are determined.

TABLE 10
Flags are used to communicate the changes in economic parameters

| Year | 2001 | 2002 | 2003 | 2004 |
|---|---|---|---|---|
| Royalty Rate | 7% | 12% | 12% | 17% |
| Flags | 1 | 2 | 2 | 3 |

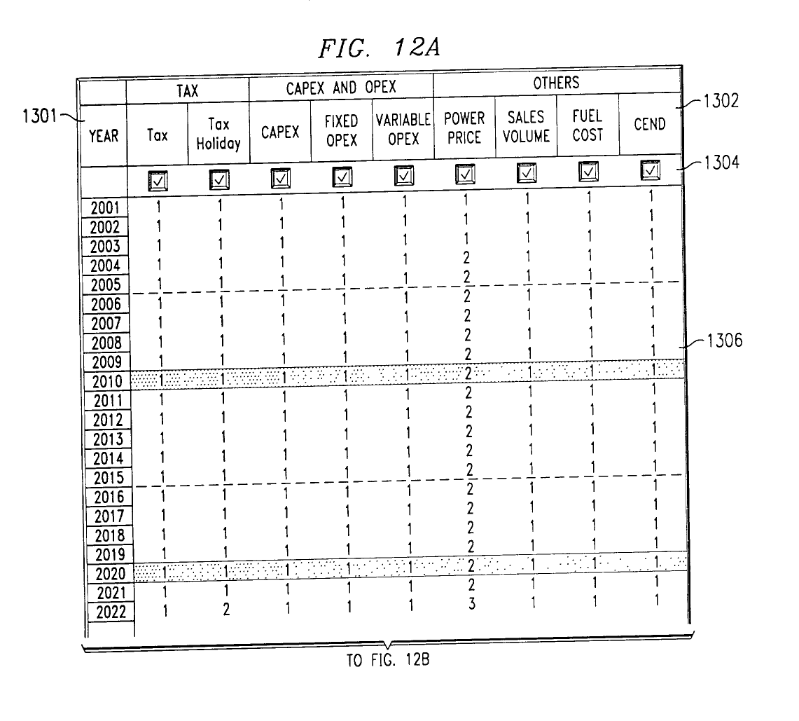

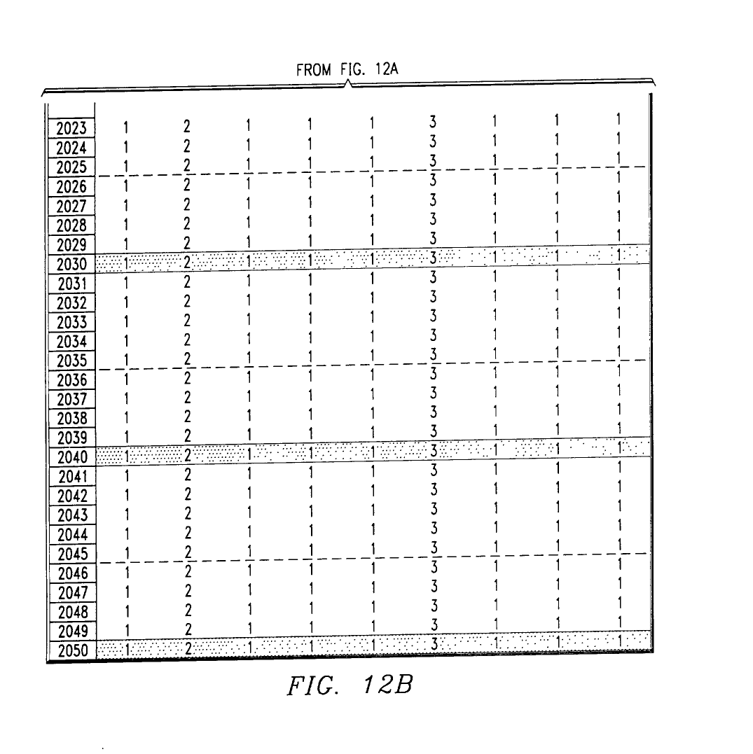

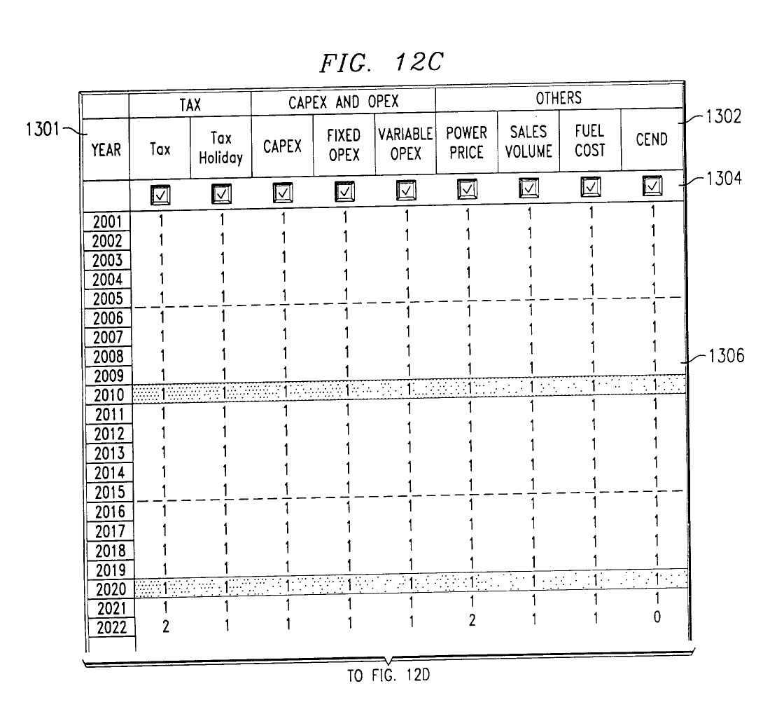

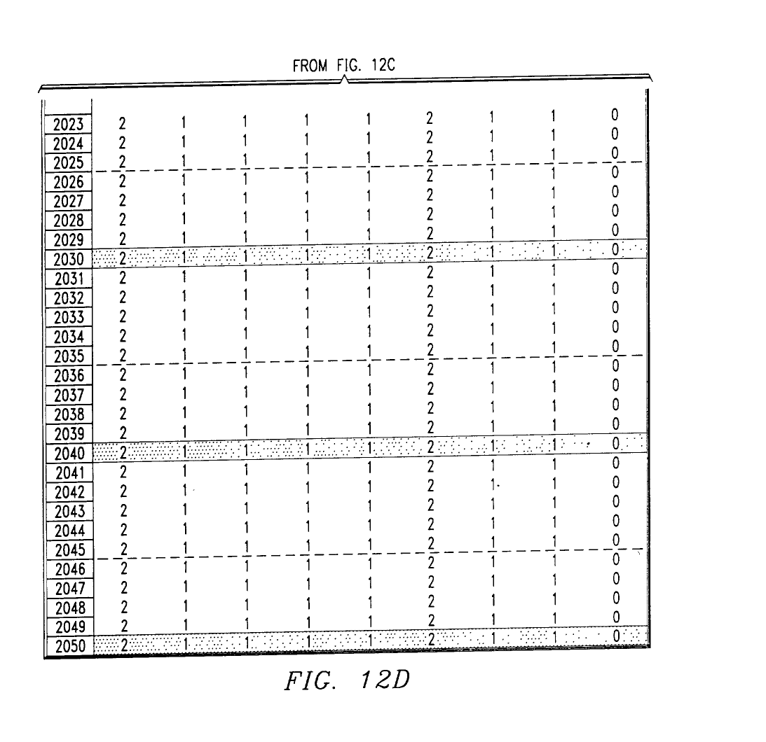

In Table 10, the initial royalty rate is 7%. In the first year of this iteration, the flag “1” indicates no change occurred. In the second year, a risk event which as defined could have impact on royalty rates occurred, raising the royalty rate by 5 percentage points to 12%, as indicated by flag “2”. In the third year, there was no change, so the royalty rate remained at 12% and the flag remains the same as the previous year. In the fourth year, yet another risk event which as defined could have impact on royalty rates occurred, causing the royalty rate to increase by another 5 percentage points to 17%, indicated by the flag “three” (NOTE: Table 10 is for purposes of illustration and the flag values for the years are different than FIG. 11). The exception to the “1-2-3” flag convention is the “CEND” risk. Instead of taking on the “1”, “2” and “3” flags, it shows a flag of “1” in the event of a confiscation and a flag of “0” for no occurrence of confiscation. Instead of producing flags, the program could directly output the royalty rates for each year, provided an integrated model that performs all the functions (estimating project economic value, generating statistical distributions and conduct probability analysis) is built from the outset. Otherwise, it is more efficient to use flags as a way to communicate between the simulation module and the economic model on a real time basis. The flags also afford a “plug-and-play” functionality to an embodiment of the invention so that it can be easily adapted to any economic model. In addition, this output format makes it easier for a user to scan and rapidly identify when and in which categories risk events are occurring. FIG. 12A illustrates the same flag output for one iteration for a power plant investment and FIG. 12B shows results of another iteration. Referring to FIGS. 12A and 12B, the charts have a column 1301 for the year, a list of the project specific risks 1302. The changes to the project economic value parameters are preferably inputted by an interface from a subroutine or other module. Microsoft Excel codes used to derive the various flag values can be found in Charts 11 and 12.

While changes in economic parameters are passed to the economic model, at the same time, the “shock events” such as extreme commodity price fluctuations or “windfall” project profits can be brought back in the simulation module. “Shock events” are events, either exogenous or endogenous, that may alter the political equilibrium between project owner/sponsor and the host government. For example: in an oil and gas development project, a hike in worldwide crude oil prices may provide the host government an excuse to extract more concessions from project owner, in the form of, but not limited to: higher taxes, community “donations”, etc. One way the shocks can be incorporated in the simulation is as follows: in the years when cumulative project returns such as risked IRR exceed a threshold value (assume 20%), the project specific political event risk probabilities for all subsequent years are increased by 10% to reflect the heightened possibility that the host government will claim a portion of the incremental project cash flow.

i. Updating the Unrisked Economic Model

The unrisked economic model will require some modifications to recognize the flags “1”, “2”, or “3” flags it receives via the datalink. And it needs instructions to know what are the appropriate levels of economic parameters that correspond to various flags, box 134. FIG. 2B. In the preferred embodiment, the economic model is programmed, and data tables set up to provide corresponding values for economic parameters. For example a data table for royalty rates could be: Royalty Flag “1”=5%, Royalty Flag “2”=10%, Royalty Flag “3”=15%. Thus, the simulation module determines the value of the royalty flags and other flags for the iteration, these flags are inputted into the economic model and the values corresponding to the flags are used to modify the economic model for that iteration. As explained previously the simulation model could directly output the altered economic parameters rather than flags if desired. The details of step-by-step integration instruction can be found in Chart 9. Chart 10 provides the detailed Excel codes which is programmed to update the baseline economic model to set up the data table and to interpret the flags sent by the simulation module.

j. Conducting Monte Carlo Analysis to Obtain Risked Project Value Metrics

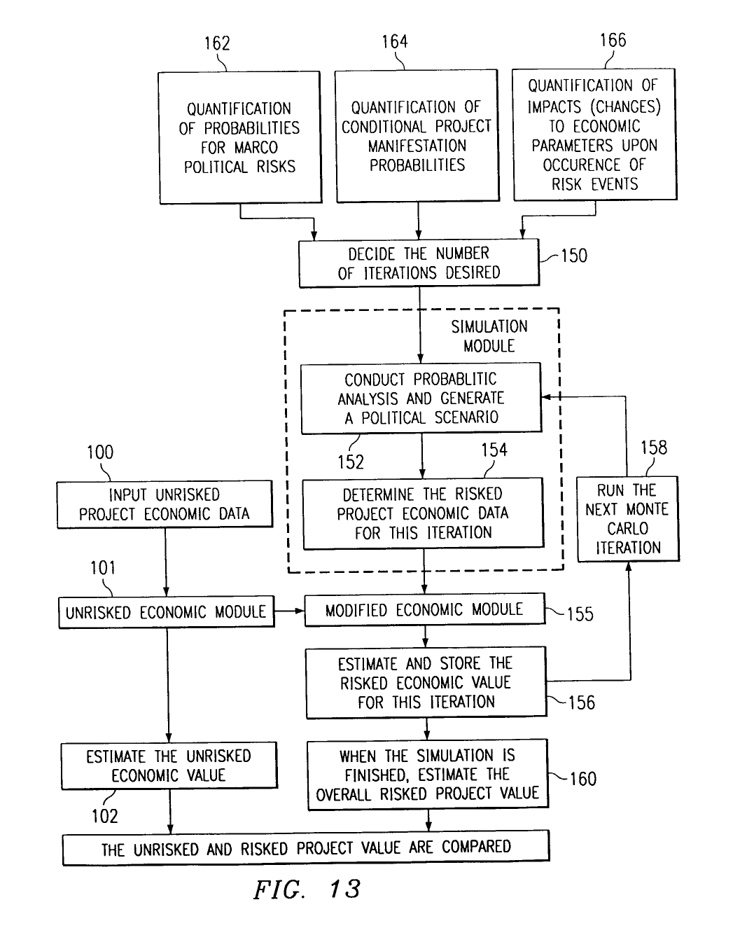

A probabilistic assessment is conducted, block 136, FIG. 2B. In the preferred embodiment, the Microsoft excel program and the “Crystal Ball” add-in (sold by Decisioneering, Inc) are used to simulate all possible political outcomes, based on the probabilities previously inputted. FIG. 13 provides an illustration of this iterative process and the processes involved in deriving the risked and unrisked project economic value. After the macro political risk quantifications, conditional risk probabilities of project manifestations, and impacts to economic parameters are defined, the simulation can begin. First the number of desired iterations is determined, block 150. For each iteration of the simulation, one possible instance of a political risk scenario is generated, block 152, and changes if any, to the economic parameters for all the years of the project are determined, block 154. The risked project economic parameters are inputted to the economic module to create a modified economic model, block 155, which will calculate the valuation metric under that given simulated scenario, block 156. The results for each iteration are recorded. The simulation is repeated until the predetermined number of scenarios is reached, block 158. In a preferred embodiment, the simulation run should have 3,000 or more iterations to generate results that are considered statistically stable. When the simulation is finished, the overall risked project value matrices will be estimated using the recorded results of the individual iterations, block 160. These value metrics could be the average of the NPV—Net Present Values, or average of the IRR—Internal Rate of Returns or a cumulative percentile distribution of NPV or IRRs (or other desired valuations).

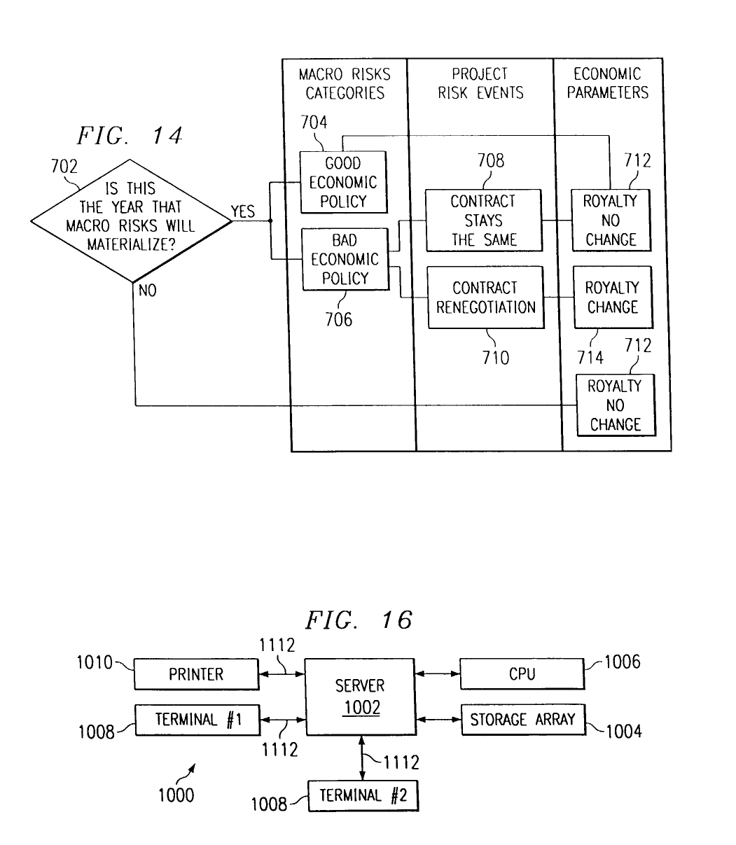

To better understand the Monte Carlo process, FIG. 14 provides an illustration of a Monte Carlo analysis using the simplified 4-year project example, assuming one macro political risk category—“Domestic Economic Risk”, one political risk event—“Renegotiation of Contract” and one project economic parameter—“Royalty Rate”. In each year, there is a determination whether this is the year during which risk events will materialize, 702. This determination depends on the timing distribution (which is used to apportion the macro category multi-year cumulative risk probabilities into single-year risk probabilities) that the user previously defined. If the determination is positive, two macro economic outcomes will emerge: good economic policy 704 or bad economic policy 706. The probabilities of good outcome versus bad outcome is defined by the annul risk probabilities under the macro economic policy category. In the event of a good economic outcome, the royalty rate will stay the same; whereas in the case of bad economic outcome, it could result in two project risk event outcomes: renegotiation of contract, 708, or no contract renegotiation, 710. The probabilities of renegotiation versus no renegotiation is defined by the conditional project manifestation probabilities. Contract renegotiation leads to change in royalty rate, 714. All other paths lead to no royalty rate change, 712. Each of these steps will be repeated for the second, third, and fourth year of the project, with incremental complexities. Due to space constraints, FIG. 14 only illustrates the decision paths for the first year of the project. If all branches are charted for this simplified four-year project, there would be a total of 16 separate possible paths (4 paths per year). This process increases in complexity as the number of macro categories, the numbers of project specific risk events, and the number of project economic parameters are expanded. In essence, this invention allows one to investigate the project over each possible distinctive path to derive a compressive view of how the project value will likely be impacted by political uncertainties.

k. Comparing Results

The results of a Monte Carlo run with 3,000 or more iterations, in a preferred embodiment, are averaged to arrive at the final risked economic evaluation of the project which takes into account potential political risks, block 138. FIG. 2B. This allows the business personnel to compare the unrisked project value to the risk project value, block 140. FIG. 2B. It also allows for the comparison of the risk project values between two or more competing projects. Additionally, the “Crystal Ball” program allows the economic impact of the potential political risks on the project to be displayed in other formats, such as, a probability percentile listing of occurrence of all possible results, which it generates based on the results of the individual iterations.

l. Conducting Two-Dimensional Sensitivity Analysis

At this point, a two-dimensional sensitive analysis on political uncertainties can be conducted to determine: a) the extent to which each project specific risk event impacts the project value, or b) the extent to which each economic parameter impacts the project value (impacted by political uncertainties). In the present invention, a sensitivity analysis can easily be performed by selecting certain risk elements to be included or excluded from the simulation. This allows the business desires to focus upon and study the impact of individual risks or particular groups of risk. In FIGS. 6A and 6B, the checkboxes 560 adjacent to project specific risk events are used to select which risks are included and which ones are excluded in the simulation (checked boxes indicate the risk adjacent to it is included in the simulation, otherwise the risk is excluded in the simulation). For example, if the business is curious to know the extent that the project specific risk event—“Confiscation of project assets and bank accounts” impacts the project value, or the cost to the business to eliminate that risk, a Monte Carlo simulation will be run with the checkbox adjacent to that risk event selected with others checkboxes unselected (Thus, the simulation and economic model will run assuming none of the other risks events occur during the simulation). The difference between results generated from this simulation and the base line result will provide the business with the effect or cost of that risk. (Naturally, if all the checkbox are un-selected, the simulation results is the same as the unrisked project economics). A sensitivity analysis can be very useful in some cost/benefit analysis. Let us assume that the business has an opportunity to purchase a political risk insurance policy that provides coverage for any potential loss resulting from the confiscation of project assets. Then the benefit of this insurance (the impact of the confiscation risk to project value) can be compared with the premium cost of the insurance to determine if it makes business sense to subscribe to such an insurance policy. In addition, another benefit of having the ability of isolating each risk event of the political uncertainties is it makes tracing through the computer codes for debugging purposes. The checkboxes 806 in FIGS. 11A and C serve the same functions. By excluding and including one or more the economic parameters in the simulations (leaving other economic parameters in their unrisked state throughout the simulations), the business will know precisely how these project economics parameters impact the overall project value as a result of political uncertainties. For example, it is possible to determine the extent to which political risks associated with crude oil price uncertainties, or production volume uncertainties will impact the final project value.

FIG. 15 illustrates the results of the Monte Carlo simulation and the results of the sensitivity analysis for the illustrated embodiment. The worth of the unrisked project is estimated to be $470 million, but that value is reduced by $240 million after incorporating political uncertainties to produce a risked value of $230 million, item 902. In addition, graph 904 shows how each project specific event risk affects the value of the project as a result of the sensitivity analysis. Each project risks 906 are provided on the Y-axis, and the dollar amount in millions is shown along the X-axis. The bars 908 (only two labeled for illustration) show the dollar impact of the various project event risks on the project value. This chart can be helpful in assisting the managers focus on the risk events with the greatest potential impact on the project and investigate available alternatives to mitigate those risks.

m. Storing Results

The results of the risk analysis can be stored in the computer (see FIGS. 6-11). The results for various projects can be compared and the information can be considered in making the investment decisions. As a project progresses, the risk analysis can be updated taking into account changes in the political environment and risk quantifications which occur after the initial evaluation to determine if the project should be continued or abandoned.

n. System Operating Environment

In the system of the present invention, any suitable data processing system can be employed such as a computer which preferably has an input device, central processing unit, an output device, and a storage device. Suitable computers include commonly known and used personal computers, mainframe computers, or a network of computer devices as are available in a wide variety of configurations.

FIG. 16 schematically illustrates a hardware environment of an embodiment of the present invention. A computer system 1000 has a server 1002 in communication with a storage device 1004 and a central processing unit 1006. The server 1002 can be connected to a network having terminal(s) 1008, and can be connected to additional suitable output devices such as a printer 1010, via a communications network 1112. Alternatively, the computer system 1000 can be a personal computer, workstation, minicomputer, mainframe, or any combination thereof. The network 1012 can be a private network, a public network or any combination thereof, including local-area networks (LANs), wide-area networks (WANs), or the Internet. The storage array 1004 can include one or more hard disk drives, tape drives, CD drives, solid state memory devices, or other types of storage devices.

The computer system 1000 can be divided into a front-end portion and a back-end portion. The front-end includes a user interface, which can be provided at terminal 1008. The terminal 1008 can be directly connected to the computer system 1000, or can be connected to the computer system 1000 via the network 1012. The processing jobs can then be submitted to a desired hardware platform (e.g., in the back-end).

Recap of the Preferred Embodiment

FIG. 13 illustrates the complete program of a preferred embodiment. The macro political risk probabilities are quantified to capture the likelihood of the occurrence of various macro political risk events (e.g., major terrorist attack, enactment of capital control, significant baking crisis, etc.) 162. The project conditional manifestation risk probabilities are quantified to capture the likelihood of the occurrence of various project specific risk event given the occurrence of the an associated macro risk event (e.g., renegotiation of contract given the occurrence of banking crisis; or physical disruption of project operation given the occurrence of a major terrorist attack, etc.) 164. Impacts (changes) to the economic value parameters as a result of the occurrence of a risk event were quantified (e.g., change in tax rate in the event of the renegotiation of contract terms; or change in production volume in the event of a physical disruption of project operation, etc.) 166. The user then inputs the number of iterations this Monte Carlo simulation process encompasses. The simulation module, housed in an Excel program, contains the predetermined relationships among the macro political risks, the project specific political risks and project economic parameters. For each Monte Carlo iteration, the simulation module conducts statistical calculations based on the set of randomly drawn numbers (from a predefined distribution), and then compares the numbers with the pre-defined probabilities of occurrence of macro and project specific risk events, to determine when and if any macro risk events have occurred, when and if any project specific political risk events have occurred and when and if any project economic parameters have changed and generates an output of flags for project parameters if necessary. The various flags for each project parameters (representing the magnitude of changes, if any, to parameters) are fed into the economic model block 154, which is modified from an unrisked economic module, block 101 to estimate the project economic value for that given iteration. The control of the iteration can be accomplished by any Monte Carlo analysis, which performs a commercial program such as the “Crystal Ball” program or any other suitable program. In other words, the “Crystal Ball” program acts as a policeman that ensures an orderly simulation process, by repeating the iterations until the desired number of iterations is reached. The results (project economic values) from each iteration are stored in the “Crystal Ball” program. When the simulation is finished or when the pre-defined number of simulation is reached, the “Crystal Ball” program will estimate the overall risk project value by averaging the outcomes of all results (“Crystal Ball” also does other functions, such as: displaying and charting results for each iteration, among others). This final risked project value, representing the expected project value incorporating impacts of political uncertainties can be relied upon in the decision making process.

CHART I
DRI-WEFA's threshold definitions for the macro political risks used in the illustrated
embodiment

| Macro Risk | DRI-WEFA's Threshhold |
|---|---|
| Corporate Capital Gains Tax Risk | A 10-percentage point increase in the rate of capital gains |
| | tax for foreign-owned businesses during any 12-month |
| | period, with respect to the level at the time of the |
| | assessment. |
| Corporate Income Tax Risk | A 10-percentage point increase in the rate of corporate |
| | income tax during any 12-month period, with respect to the |
| | level at the time of the assessment. |
| Export Tax Risk | A 5-percentage point increase in the average rate of export |
| | taxes during any 12-month period, with respect to the level |
| | at the time of the assessment. |
| Import Tax Risk | A 10-percentage point increase in the average rate of |
| | import taxes/tariffs during any 12-month period, with |
| | respect to the level at the time of the assessment. |
| Withholding Tax Risk | A 5-percentage point increase in the average rate of |
| | withholding taxes during any 12-month period with respect |
| | to the level at the time of the assessment. |
| Enforceability of Gov. Contracts Risk | A 1-point increase on a scale of “0” to “10” in the |
| | enforceability of contracts during any 12-month period, |
| | with respect to the level at the time of the assessment (“0” |
| | on the scale means absolute enforceability and no loss, and |
| | “10” means no enforceability). |
| Enforceability of Private Contracts | A 1-point increase on a scale of “0” to “10” in the legal |
| Risk | enforceability of contracts during any 12-month period, |
| | with respect to the level at the time of the assessment (“0” |
| | on the scale means absolute enforceability and no loss, and |
| | “10” means no enforceability). |
| Environmental Regulations Risk | An increase in environmental regulations, with respect to |
| | their level at the time of the assessment, that reduces total |
| | aggregate investment in real LCU terms by 5 percentage |
| | points. |
| Export Regulations Risk | A 2% reduction in export volume as a result of a |
| | worsening in export regulations or restrictions (such as |
| | export limits) during any 12-month period, with respect to |
| | their level at the time of the assessment. |
| Import Regulations Risk | A 2% reduction in import volume as a result of a |
| | worsening in import regulations or restrictions (such as |
| | import quotas) during any 12-month period, with respect to |
| | their level at the time of the assessment. |
| Inflation Risk | An increase of 5 percentage points in CPI inflation for any |
| | 12-month period above the rate prevailing during the last |
| | 12 months. |
| Default/Restructuring by Bank Risk | A 10% reduction in the present value of U.S. dollar- |
| | denominated loans to private-sector domestic banks as a |
| | result of future changes in payment terms during any 12- |
| | month period (in real LCU terms). |
| Default/Restructuring on Govt. Loans | A 10% reduction in the present value of U.S. dollar- |
| Risk | denominated loans to the domestic public sector as a result |
| | of future changes in payment terms during any 12-month |
| | period (in real LCU terms). |
| Domestic Demand Risk | A decline of 5 percentage points below the projected |
| | growth path in domestic demand during any 12-month |
| | period. |
| Corruption Risk | A 1-point increase on a scale from “0” to “10” in |
| | corruption during any 12-month period, with respect to the |
| | level at the time of the assessment. (Corruption is |
| | measured on a 10-point scale, with “0” representing no |
| | corruption, and “10” representing a level of corruption |
| | where no transaction is possible without it). |
| Military Coup Risk | A military coup d'etat (or a series of such events) that |
| | reduces the GDP growth rate by 2% during any 12-month |
| | period. |
| Major Insurgency/Rebellion Risk | An increase in scope or intensity of one or more |
| | insurgencies/rebellions that reduces the GDP growth rate |
| | by 3% during any 12-month period. |
| Terrorism Risk | An increase in scope or intensity of terrorism that reduces |
| | the GDP growth rate by 1% during any 12-month period. |
| Civil War Risk | An increase in scope or intensity of one or more civil wars |
| | that reduces the GDP growth rate by 4% during any 12- |
| | month period. |
| Labor Strike and Unrest Risk | An increase in scope, intensity, or frequency of labor |
| | strikes/turmoil that reduces the GDP growth rate by 1% |
| | during any 12-month period. |
| Government Ineffectiveness Risk | A decline in government personnel quality at any level that |
| | reduces the GDP growth rate by 1% during any 12-month |
| | period. |
| Institutional Failure Risk | A deterioration of government capacity to cope with |
| | national problems as a result of institutional rigidity or |
| | gridlock that reduces the GDP growth rate by 1% during |
| | any 12-month period. |
| Economic Sanctions Risk | An increase in scope or intensity of economic sanctions |
| | that reduces the GDP growth rate by 2% during any 12- |
| | month period. |
| Trade Conflict Risk | An increase in scope or intensity of a trade conflict that |
| | reduces the GDP growth rate by 2% during any 12-month |
| | period. |
| Military Mobilization/Small Inter- | An increase in scope or intensity of an inter-state military |
| State War Risk | conflict that reduces the GDP growth rate by 2-5% during |
| | any 12-month period. |
| Major Inter-State War Risk | An increase in scope or intensity of a military conflict that |
| | reduces the GDP growth rate by more than 5% during any |
| | 12-month period. |

CHART 2
Quantification of conditional project manifestation probabilities via a multi-variant
decision hierarchy scoring system (TABLE 7 CONTINUED)

| Macro Risk Category | | | Regulation | |
|---|---|---|---|---|
| Project Manifestations | | | Fiscal Regime Modified/ | |
| | Sectional | | Renogotiated | |
| | Weightings | Questions | Available Answers | Scores |
| 1 | 30% | Does the project meet local SHE | Vastly Exceed | 0 |
| | | (Safety Health & Environmental) | [symbol] | [symbol] |
| | | standards? | Meet | 50 |
| | | | Inferior | 100 |
| | | | Don't Know | 25 |
| 2 | 15% | Current state of the local SHE (Safety | Very Strong | 0 |
| | | Health & Environmental) legislation? | Strong | 15 |
| | | | Average | 30 |
| | | | [symbol] | [symbol] |
| | | | Very Weak | 60 |
| 3 | 35% | Does the contract stipulate local | [symbol] | [symbol] |
| | | content thresholds? | Don't Know | 25 |
| | | | No | 10 |
| 4 | 15% | Does the project import equipment? | [symbol] | [symbol] |
| | | | Don't Know | 15 |
| | | | No | 0 |
| 5 | 5% | Does the project dispose of used | [symbol] | [symbol] |
| | | equipment locally? | Don't Know | 0 |
| | | | No | 15 |
| Total | 100% | | | |

CHART 3

| Macro Risk Category | | | Domestic Economic | |
|---|---|---|---|---|
| Project Manifestations | | | Currency Devaluation | |
| | Weightings | Questions | Available Answers | Possible Score |
| 1 | 30% | Any devaluation over the last 20 | Devastating | 100 |
| | | years? | [symbol] | [symbol] |
| | | | Some | 10 |
| | | | Little | 0 |
| | | | No | 0 |
| 2 | 15% | Free float or pegged, currency | [symbol] | [symbol] |
| | | board? | Pegged | 15 |
| | | | C. Board | 5 |
| | | | Controlled | 0 |
| 3 | 35% | Does the Central Bank have | Certain | 0 |
| | | credibility? | High | 20 |
| | | | Toss | 40 |
| | | | Moderate | 50 |
| | | | [symbol] | [symbol] |
| | | | Don't Know | 40 |
| 4 | 15% | Is the country's economy export | Yes | −30 |
| | | oriented (in additon to petroleum | Don't Know | 0 |
| | | export)? | [symbol] | [symbol] |
| 5 | 5% | Trading patterns (current & capital | Yes | 0 |
| | | account)? | Don't Know | 25 |
| | | | [symbol] | [symbol] |
| Total | 100% | | | |

CHART 4

| | | | Political Institutions | |
|---|---|---|---|---|
| Macro Risk Category | | | Fiscal Regime/Contract | |
| Project Manifestations | | | Negotiation Delay | |
| | Weightings | Questions | Available Answers | Possible Score |
| 1 | 0% | Status of the asset? | Producing | No risk |
| | | | [symbol] | calculated |
| 2 | 50% | Is current project timeframe | Yes | 0 |
| | | realistic? | Don't Know | 50 |
| | | | [symbol] | [symbol] |
| 3 | 50% | Support of the project at all | Very Strong | 0 |
| | | levels of the government? | Strong | 15 |
| | | | Average | 30 |
| | | | Weak | 45 |
| | | | [symbol] | [symbol] |
| Total | 100% | | | |

CHART 5

| | | | Regulation | |
|---|---|---|---|---|
| Macro Risk Category | | | Routing Agreement Modified/ | |
| Project Manifestations | | | Renegotiated | |
| | Weightings | Questions | Available Answers | Possible Score |
| 1 | 66% | Does the pipeline meet local | [symbol] | [symbol] |
| | | SHE standards? | Exceed | 20 |
| | | | Meet | 50 |
| | | | Inferior | 100 |
| | | | Don't Know | 25 |
| 2 | 34% | Current state of the local SHE | Very Strong | 0 |
| | | legislation | Strong | 15 |
| | | | Average | 30 |
| | | | [symbol] | [symbol] |
| | | | Very Weak | 60 |
| Total | 100% | | | |

CHART 6

| Macro Risk Category | | | Domestic Economic | |
|---|---|---|---|---|
| Project Manifestations | | | Confiscation of Project Assets | |
| | Weightings | Questions | Available Answers | Possible Score |
| 1 | 0% | Are there real (hard) assets in | [symbol] | [symbol] |
| | | the country? | Don't Know | Don't Know |
| | | | No | No |
| 2 | 25% | Any outright CEND in the last | [symbol] | [symbol] |
| | | 20 years? | Significant | 15 |
| | | | Some | 5 |
| | | | Little | 0 |
| | | | No | 0 |
| 3 | 30% | Any legal structure that | Yes | −5 |
| | | alleviate this possibility? | Don't Know | 0 |
| | | | [symbol] | [symbol] |
| 4 | 22.5% | Does financing involve any | [symbol] | [symbol] |
| | | Supranationals? | Don't Know | 0 |
| | | | No | 0 |
| 5 | 22.5% | Does the partnership structure | Yes | −5 |
| | | alleviate risk? | Don't Know | 0 |
| | | | [symbol] | [symbol] |
| Total | 100% | | | |

CHART 7

| Macro Risk Category | | | War/Terrorism/Labor | |
|---|---|---|---|---|
| Project Manifestations | | | Physical Disruption | |
| | Weightings | Questions | Available Answers | Possible Score |
| 1 | 0% | Is the project off-shore? | Yes | Reduced |
| | | | Don't Know | Don't Know |
| | | | [symbol] | [symbol] |
| 2 | 25% | Is the project located in a | Yes | 80 |
| | | territorial dispute zone? | Don't Know | 20 |
| | | | [symbol] | [symbol] |
| 3 | 25% | Located in regions prone | Certain | 80 |
| | | to interstate wars/civil | High | 60 |
| | | wars? | Toss | 40 |
| | | | Moderate | 20 |
| | | | [symbol] | [symbol] |
| | | | Don't Know | 10 |
| 4 | 10% | Any extreme groups that | Certain | 25 |
| | | targets Oil | High | 20 |
| | | projects/foreigners? | Toss | 15 |
| | | | Moderate | 10 |
| | | | [symbol] | [symbol] |
| | | | Don't Know | 5 |
| 5 | 22.5% | Does the project exceed | [symbol] | [symbol] |
| | | local labor standards? | Exceed | 20 |
| | | | Meet | 50 |
| | | | Inferior | 100 |
| | | | Don't Know | 25 |
| 6 | 12.5% | Current state of the local | Very Strong | 0 |
| | | labor legislation | Strong | 15 |
| | | | Average | 30 |
| | | | Weak | 45 |
| | | | [symbol] | [symbol] |
| 7 | 5% | Is the labor force | Yes | 30 |
| | | unionized and aggressive? | Don't Know | 0 |
| | | | [symbol] | [symbol] |
| Total | 100% | | | |

CHART 8

| Macro Risk Category | | | Domestic Economic | |
|---|---|---|---|---|
| Project Manifestations | | | Capital Control | |
| | Weightings | Questions | Available Answers | Possible Score |
| 1 | 20% | Capital control enacted over the | Devastating | 50 |
| | | last 20 years? | Significant | 20 |
| | | | Some | 5 |
| | | | Little | 0 |
| | | | No | 0 |
| 2 | 25% | Is project's revenue derived | Yes | 15 |
| | | from local market vs. export? | Don't Know | 0 |
| | | | No | −5 |
| 3 | 15% | Does financing involve any | Yes | −5 |
| | | Supranationals? | Don't Know | 0 |
| | | | No | 0 |
| 4 | 20% | Does the partnership structure | Yes | −5 |
| | | alleviate risk? | Don't Know | 0 |
| | | | No | 0 |
| 5 | 5% | Is the country's economy export | Yes | −30 |
| | | oriented? | Don't Know | 0 |
| | | | No | 20 |
| 6 | 15% | Is the currency freely | Yes | 0 |
| | | convertible? | Don't Know | 10 |
| | | | No | 30 |
| Total | 100% | | | |

CHART 9
Step-by-Step Guidelines on Modifying the Economic Module to Link the Simulation
Module (named “PreACT”)
Step 1: Prepare the economic model for integration with PreACT

| | | |
|---|---|---|
| Go over the economic model and | PreACT Category | Select Economic |
| identify the key economic | | Assumptions |
| assumptions/variables that are | | |
| sensitive to political uncertainties. | | |
| | Fixed Facility CAPEX | Central Facility CAPEX |
| | | Well Facility Capex |
| | Well/Drilling CAPEX | Production Drilling Cost |
| | | Injection Water Drilling |
| | | Cost |
| | | Water Source Drilling Cost |
| | | Gas Disposition Drilling |
| | | Cost |
| | | Water Deposit Drilling Cost |
| Group all identified variables into | Fixed OPEX General | General Fixed OPEX |
| categories that are recognized by | | Export Pipeline OPEX |
| PreACT (use PreACT level III | | Environmental & Land |
| template) | | OPEX |
| | Variable OPEX | Production Well OPEX |
| | | Water Injection OPEX |
| | Abandonment CAPEX | |
| | Movable Facility | |
| | CAPEX | |
| Before start modifying the model, | Transportation Pipeline | |
| make sure all calculations that | CAPEX | |
| involve key political risk variables | | |
| are in vector formats | | |

Step 2: Add Risked Contract Assumptions

Modify Fiscal Regime/Contract Term input sheet to add risked 1 (one risk event has occurred) & risk 2 (two risk events have occurred) inputs and name the newly—created cells accordingly. This can be done by simply adding two cells to the right of the original input.

### EXAMPLE

| | | After | | |
|---|---|---|---|---|
| | Before | Cost | Cost Recovery | Cost Recovery |
| Assumption | Cost Recovery | Recovery | Risk 1 | Risk 2 |
| Cell Name | COST_{—RECOVERY} | COST_{—RECOVERY} | COST_{—RECOVERY} | COST_{—RECOVERY} |
| | | | R1 | R2 |

COST_RECOVERY_R1 = COST_RECOVERY + preACT.x1s!COST_RECOVERY_DELTA_R1

Step 3: Add Risked OPEX Assumptions

Modify OPEX input sheets to add risked 1 (one risk event has occurred) & risk 2 (two risk events have occurred) inputs and name the cells accordingly. Again, this can be done by simply adding two cells to the right of the original input.

### EXAMPLE

| | Before | After | | |
|---|---|---|---|---|
| | General | General | | |
| | Operating | Operating | General Operating | General Operating |
| Assumption | Expenditure | Expenditure | Expenditure - Risk 1 | Expenditure - Risk 2 |
| Cell Name | GEN_OPEX | GEN_OPEX | GEN_OPEX_R1 | GEN_OPEX_R2 |

GEN_OPEX_R1 = GEN_OPEX* (1 + PreACT.x1s!FIXED_OPEX_DELTA_R1)
GEN_OPEX_R2 = GEN_OPEX_R1* (1 + PreACT.x1s!FIXED_OPEX_DELTA_R2)

Step 4: Add Medium-Term and Long-Term Risked CAPEX Assumptions

Modify CAPEX input sheets to add risked 1 (one risk event has occurred) & risk 2 (two risk events have occurred) inputs and name the cells accordingly

### EXAMPLE

| | Before | After | | |
|---|---|---|---|---|
| | Well Facility | Well Facility | Well Facility | Well Facility |
| Assumption | Expenditure | Expenditure | Expenditure - Risk 1 | Expenditure - Risk 2 |
| Cell Name | WELL_{—} | WELL_{—} | WELL_{—} | WELL _{—} |
| | FACILITY_{—} | FACILITY_{—} | FACILITY_{—} | FACILITY_{—} |
| | CAPEX | CAPEX | CAPEX_R1 | CAPEX_R2 |

WELL_FACILITY_CAPEX_R1 = WELL_FACILITY_CAPEX* (1 + PreACT.xls!FIXED_CAPEX_DELTA_R1)
WELL_FACILITY_CAPEX_R1 = WELL_FACILITY_CAPEX_R1* (1 +PreACT.xls!FIXED_CAPEX_DELTA_R2)

Step 5: Risk Project Schedule Timing

Change the timing of key pre-production events, namely the exploration schedule, the drilling schedule and the start of production to reflect possible delays as a result of political uncertainties.

### EXAMPLE

| | | After | |
|---|---|---|---|
| | Before | | State of Production |
| Assumption | State of Production | State of Production | (Risked) |
| Cell Name | FIRST_OIL_YEAR | FIRST_OIL_YEAR | FIRST_OIL_YEAR_R |

FIRST_OIL_YEAR_R = FIRST_OIL_YEAR + PreACT.xls!FIRST_OIL_DELAY

Step 6: Risk Production Profile

Modify production profile to accommodate delays in first oil and disruptions in operation. Make sure the production schedule is listed in a relative format: year 1-50, not 2001-2050.

This involves the creation of a vector, in-production indicators: (1 denotes the filed is in production, 0 otherwise). In other words, any years preceding to first production, along with any years that production is disrupted will show zeros, the rest will show 1s.

| | |
|---|---|
| PRODUCTION_INDICATORS_R = | IF (YEARS<FIRST_OIL_YEAR_R, O, |

| | |
|---|---|
| IF | (AND (YEARS |
| >=PreACT.xls!Trigger2, | |

YEARS <PreACT.xls!Trigger 2 +
PreACT.xls!PRODUCTION_{—}
DISRUPTION)).0.1))

where Trigger2 is the year in which a simulated risk event takes place during the post-production phase.

Then the in-production indicator is converted to produce a vector to tally the number of years in active production.

YEAR_IN_PRODUCTION_R=IF (PRODUCTION_INDICATOR_R=0, 0, sum ($Cell1:Cell2))

where $Cell1 is the first cell in PRODUCTION_INDICATORS_R and Cell2 is current cell corresponds to the current year.

Excel Work Functions Review

VLOOKUP(lookup_value,table_array,col_index_num,range_lookup)

Searches for a value in the leftmost column of a table, and then returns a value in the same row from a column you specify in the table.

Lookup value is the value to be found in the first column of the array.

Table_array is the table of information in which data is looked up.

Col_index_num is the column number in table_array from which the matching value must be returned.

ISNA(Value)

Returns the logical value TRUE if value is a reference to the “#N/A” (value not available) error value; otherwise it returns FALSE.

Now we can use the YEAR_IN_PRODUCTION_R to look up an unrisked production profile to produce a risked profile (first oil delay+prod. disruptions)

DAILY_PRODUCTION_R = IF (ISNA (VLOOKUP

(YEAR_IN_PRODUCTION_R,

PRODUCTION_TABLE,2)), 0, VLOOKUP
(YEAR_IN_PRODUCTION_R, PRODUCTION_TABLE 2))

where PRODUCTION TABLE has years 1-50 in column 1 and daily production volume (from ProACT) in column 2

Step 7: Replace Unrisked Economic Variables With Their Risked Counterparts

Change the formulas of risk variables identified in Step 1. Replace OPEX, CAPEX, FISCAL REGIME, and PRICE risk variables and project timing risk variables (First Oil Year, Exploration Year, and Drilling Year) with their risked counterpart using “CHOOSE” work functions

Syntax

CHOOSE(index_num.value 1,value2, . . . )

Index_num specifies which value argument is selected.

If index num is 1, CHOOSE returns value 1; if it is 2, CHOOSE returns value2; and so on.

Examples CHOOSE(2, “Kai”, “Helen”, “Daisy”, “all”) equals “Helen”

| | | |
|---|---|---|
| Before | COST_STOP= | IF (YEARS<FIRST_OIL_YEAR, 0, IF |

(SHUT_IN=′”shut-in”, 0,
COST_STOP)

| | | |
|---|---|---|
| After | COST_STOP= | IF(YEARS<FIRST_OIL_YEAR_R, 0, |

IF (SHUT_IN_R=′”shut-in”, 0,
CHOOSE
(PreACT.xls!COST_CAP_SELECT,
COST_STOP,
COST_STOP_R1, COST_STOP_R2)))

Where PreACT x1s!COST_CAP_SELECT is a vector of flags, taking on values 1, 2, or 3 (1 denotes no risk event has occurred, 2 denotes one risk event has occurred and 3 means two risk events have occurred).

Step 8: Adjust Cash Flows for CEND, and Adjust NPV for Misc. Items.

If CEND (Confiscation, Expropriation, nationalization & Disposition) happens, all subsequent cash flows (inflow & outflow) will be cut off.

Final Project Cash Flow—Cash Flow before CEND * PreACT.x1s!CEND_FLAG

where CEND_FLAG is a vector of 1s and 0s: 0 indicates nationalization has occurred.

GO to the final NPV calculation and include possible NPV reductions which have not yet captured.

NPV=NPV (before adjustment)*(1+PreACT.x1s!NPV_HAIRCUT)

CHART 10
Microsoft Excel codes to set up the data table and performed other risked calculations

| | (S) scalar (V) vector | YK Examples |
|---|---|---|
| Explanations | Risked Variables | Formulas |
| Cost Recovery Limit | COST_RECOVERY_R1 | “=COST_RECOVERY+PreACT.xls!COST_{—} |
| (R1 & R2) | (S) | RECOVERY7_DELTA_R1)” |
| Partner Carry | COST_RECOVERY_R2 | “=COST_RECOVERY_R1+PreACT.xls!COST_{—} |
| (R1 & R2) | (s) | RECOVERY7_DELTA_R2)” |
| Royalty (R1 & R2) | CARRY_R1 (S) | “=CARRY+PreACT.xls!CARRY_DELTA_R1” |
| _Gov. Take | CARRY_R2 (S) | “=CARRY_R1+PreACT.xls!CARRY_DELTA_{—} |
| Royalty Holiday | ROYALTY_R1 (S) | R2” |
| (R1 & R2) | ROYALTY_R2 (S) | “=ROYALTY+PreACT.xls!ROYALTY_DELTA_{—} |
| Tax (R1 & R2) | HOLIDAY_R1 (S) | R1” |
| Profit Oil Split (R1 & | HOLIDAY_R2 (S) | “=ROYALTY_R1+PreACT.xls!ROYALTY_{—} |
| R2) | TAX_R1 (S) | DELTA_R2” |
| _Inv. Take | TAX_R2 (S) | “=HOLIDAY+PreACT.xls!HOLIDAY_DELTA_{—} |
| | PROFIT_OIL_R1 (S) | R1” |
| | PROFIT_OIL_R2 (S0) | “=MAX(HOLIDAY_R1+PreACT.xls!HOLIDAY_{—} |
| | | DELTA_R2,0)” |
| | | “=TAX+PreACT.xls!TAX_DELTA_R1” |
| | | “=TAX_R1+PreACT.xls!TAX_DELTA_R2” |
| | | “=PROFIT_OIL+PreACT.xls!PROFIT_OIL_{—} |
| | | DELTA_R1” |
| | | “=PROFIT_OIL_R1+PreACT.xls!PROFIT_OIL_{—} |
| | | DELTA_R2” |
| FIXED | | |
| Annual general | GEN_OPEX_R1 (S) | “=GEN_OPEX*(1+PreACT.xls!FIXED_OPEX_{—} |
| OPEX (MM) | GEN_OPEX_R2 (S) | DELTA_R1)” |
| Annual Export | EXPORT_OPEX_R1 (S) | “=GEN_OPEX_R1*(1+PreACT.xls!FIXED_{—} |
| Pipeline (OPEX | EXPORT_OPEX_R2 (S) | OPEX_DELTA_R2)” |
| (MM) | ENV_OPEX_R1 (S) | “=EXPORT_OPEX*(1+PreACT.xls!FIXED_{—} |
| Annual | ENV_OPEX_R2 (S) | OPEX_DELTA_R1)” |
| Environmental | | “=EXPORT_OPEX_R1*(1+PreACT.xls!FIXED_{—} |
| OPEX (MM) | | OPEX_DELTA_R2)” |
| | | “=ENV_OPEX*(1+PreACT.xls!FIXED_OPEX_{—} |
| | | DELTA_R1)” |
| | | “=ENV_OPEX_R1*(1+PreACT.xls!FIXED_{—} |
| | | OPEX_DELTA_R2)” |
| VARIABLE | | |
| Production well | VAR_OPEX_PROD_R1 | “=VAR_OPEX_PROD*(1+PreACT.xls!VAR_{—} |
| OPEX ($/bbl) | (S) | OPEX_DELTA_R1)” |
| Water Injection | VAR_OPEX_PROD_R2 | “=VAR_OPEX_PROD_R1*(1+PreACT.xls!VAR_{—} |
| Wall OPEX ($/bbl) | (S) | OPEX_DELTA_R2)” |
| | VAR_OPEX_INJWATER_{—} | “=VAR_OPEX_INJWATER*(1+PreACT.xls!VAR_{—} |
| | R1 (S) | OPEX_DELTA_R1)” |
| | VAR_OPEX_INJWATER_{—} | “=VAR_OPEX_INJWATER_R1*(1+PreACT.xls! |
| | R2 (S) | VAR_OPEX_DELTA_R2)” |
| FIXED | | |
| Central Facilities | CENTRAL_FACILITY_CAPEX_{—} | “=CENTRAL_FACILITY_CAPEX*(1+PreACT.xls!FIXED_{—} |
| (MM/well) | R1 (S) | CAPEX_DELTA_R1)” |
| Well Facilities | CENTRAL_FACILITY_CAPEX_{—} | “=CENTRAL_FACILITY_CAPEX_R1*(1+PreACTxls |
| | R2 (S) | !FIXED_CAPEX_DELTA_R1)” |
| | WELL_FACILITY_CAPEX_{—} | “=WELL_FACILITY_CAPEX*(1+PreACT.xls!FIXED_{—} |
| | R1 (S) | CAPEX_DELTA_R1)” |
| | WELL_FACILITY_CAPEX_{—} | “=WELL_FACILITY_CAPEX_R1*(1+PreACT.xls! |
| | R2 (S) | FIXED_CAPEX_DELTA_R1)” |
| DRILLING | | |
| Oil Production | PROD_COST_PER_WELL_{—} | “=PROD_COST_PER_WELL*(1+PreACT.xls!WELL_{—} |
| Well | R1 (S) | COST_DELTA_R1)” |
| | PROD_COST_PER_WELL_{—} | “=PROD_COST_PER_WELL_R1*(1+PreACT.xls! |
| Water Injection | R1 (S) | WELL_COST_DELTA_R2)” |
| Well | INJ_COST_PER_WELL_R1 | “=INJ_COST_PER_WELL*(1+PreACT.xls!WELL_{—} |
| | (S) | COST_DELTA_R1)” |
| Water Sourcing | INJ_COST_PER_WELL_R2 | “=INJ_COST_PER_WELL R1*(1+PreACT.xls!WELL_{—} |
| Wall | (S) | COST_DELTA_R2)” |
| | WS_COST_PER_WELL_R1 | “=WS_COST_PER_WELL*(1+PreACT.xls!WELL_{—} |
| Gas Disposition | (S) | COST_DELTA_R1)” |
| Well | WS_COST_PER_WELL_R2 | “=WS_COST_PER_WELL_R1*(1+PreACT.xls!WELL_{—} |
| | (S) | COST_DELTA_R2)” |
| Waste Disposal | GAS_DISP_COST_PER_{—} | “=GAS_DISP_COST_PER WELL*(1+PreACT.xls! |
| Well | WELL_R1 (S) | WELL_COST_DELTA_R1)” |
| | GAS_DISP_COST_PER_{—} | “=GAS_DISP_COST_PER_WELL_R1*(1+PreACT.xls!WELL_{—} |
| | WELL_R2 (S) | COST_DELTA_R2)” |
| | WASTE_DISP_PER_WELL_{—} | “=WASTE_DISP_PER_WELL*(1+PreACT.xls!WELL_{—} |
| | R1 (S) | COST_DELTA_R1)” |
| | WASTE_DISP_PER_WELL_{—} | “=WASTE_DISP_PER_WELL_R1*(1+PreACT.xls!WELL_{—} |
| | R2 (S) | COST_DELTA_R2)” |
| Abandonment | ABANDON_COST_R1 (S) | “=ABAN_COST*(1+PreACT.xls!ABAN_DELTA_R1)” |
| CAPEX | ABANDON-COST-R2 (S) | |
| | PIPELINE_CAPEX_R1 (S) | “=ABAN_COST_R1*(1+PreACT.xls!ABAN_DELTA_{—} |
| Export Pipeline | | R2)” |
| CAPEX | | “=PIPELINE CAPEX*(1+PreACT.xls!TRANSPORTATION_{—} |
| | | CAPEX_DELTA_R2)” |
| | FIRST_OIL_YEAR_R (S) | “=FIRST_OIL_YEAR+PreACT.xls!FIRST_OIL_{—} |
| | DRILLING_YEAR_R (S) | DELAY” |
| | | “=IF(DRILLING_YEAR>PreACT.xls!Trigger1,DRILLING_{—} |
| | EXP_YEAR_R (S) | YEAR,DRILLING_YEAR+PreACT.xls!FIRST_{—} |
| | | OIL DELAY)” |
| | | “=IF(EXP_YEAR>PreACT.xls!Trigger1,EXP_YEAR,EXP_{—} |
| | | YEAR+PreACT.xls!FIRST_OIL_DELAY)” |
| A string of 1s and 0s | PRODUCTION_INDICATORS_{—} | “=IF(YEARS<FIRST_OIL_YEAR_R,0,IF(AND |
| (1 if in production, 0 if not) | R (V) | (YEARS>=PreACT.xls!Trigger2, |
| | | YEARS<PreACT.xls!Trigger2+PreACT.xls!PRODUCTION_{—} |
| Number of years in active | | DISRUPTION))0,1))” |
| production | YEAR_IN_PRODUCTION_{—} | |
| | R (V) | “=IF(PRODUCTION_INDICATOR_R=0,0,sum($Cell1 |
| Lookup an unrisked | | :Cell2))” where $Cell 1 is the first cell in |
| production profile to | | PRODUCTION_INDICATORS_R and Cell2 is current |
| produce a risked profile | DAILY_PRODUCTION_R | cell corresponds to the current year |
| (first oil dealy+prod. | (V) | “=IF |
| disruptions) | | (ISNA(VLOOKUP(YEAR_IN_PRODUCTION_R, |
| | | PRODUCTION_TABLE,2)),0, |
| | | VLOOKUP(YEAR_IN_PRODUCTION_R,PRODUCTION_{—} |
| | | TABLE 2))” where PRODUCTION TABLE has |
| | | years 1_50 as column 1 and daily production volume |
| | | (from ProACT) in column 2 |
| | CAPEX_Calculation | CAPEX_Calculation_R |
| | OPEX_Calculation | OPEX_Calculation_R |
| | COST_RECOVERY_ | COST_RECOVERY_Calculation_R |
| | Calculation | PROJECT_EMV_R |
| | PROJECT_EMV | |
| notice FIRST_OIL_YEAR | Original COST_STOP (V) | “IF(YEARS<FIRST_OIL_YEAR,0,IF |
| in the original formula is | | (SHUT_IN_R=“shut_in”,0,COST_STOP)” |
| replaced by its risked | RISKED COST_STOP (V) | |
| counterpart and a | | “IF(YEARS<FIRST_OIL_YEAR,0,IF |
| CHOOSE statement will | Vector based variable sectors | (SHUT_IN_R=“shut_in”,0,COST_STOP)CHOOSE(Pre |
| select the appropriate risk | _CEND_FLAG, | ACT.xls!COST_CAP_SELECT,COST_STOP, |
| variable based on vector | COST_CAP_SELECT, | COST_STOP_R 1,COST_STOP_R2)))” |
| based PreACT generated | CARRY_SELECT, | |
| the scenarios | ROYALTY_SELECT, | |
| | TAX_SELECT, | |
| | HOLIDAY_SELECT, | |
| | FIXED_OPEX_SELECT, | |
| | VAR_OPEX_SELECT, | |
| | MOVABLE_CAPEX_SELECT, | |
| | FIXED_CAPEX_SELECT, | |
| | TRANSPORTATION_CAPEX_{—} | |
| | SELECT, | |
| | PRICE_SELECT, | |
| | TAX_SELECT | |
| If CEND (Confiscation, | NVP_POST_CEND | “=NVP_PRE_CEND*PreACT.xls!CEND_FLAG” |
| Expropriation, | | where CEND_FLAG is a vector of 1s and 0s |
| Nationalization & | | |
| Disposition) happens, all | | |
| subsequent cash flows | | |
| (inflow and outflow) will | | |
| be cut off | | |
| GO to the final NPV | NPV_R (S) | “=NPV_POST_CEND*(1+PreACT.xls!NVP_HAIRCUT)” |
| calculation and include | | |
| possible NPV reductions | | |

CHART 11
Sample Microsoft Excel Codes used to derive the “Royalty” flags by year

| | |
|---|---|
| 2001 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2002 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2003 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2004 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2005 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2006 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2007 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2008 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2009 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2010 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2011 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2012 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2013 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2014 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2015 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2016 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2017 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2018 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2019 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2020 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2021 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2022 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2023 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2024 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2025 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2026 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2027 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2028 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2029 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2030 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2031 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2032 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2033 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2034 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2035 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2036 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2037 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2038 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2039 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2040 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2041 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2042 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2043 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2044 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2045 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2046 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2047 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2048 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2049 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |
| 2050 | =IF(ROYALTY_ON,IF(YEARS>=TRIGGER_1,IF(ROYALTY_DELTA_PRE<>0,1,0), |
| | 0)+IF(YEARS>=TRIGGER_2,IF(ROYALTY_DELTA_POST<>0,1,0),0)+1,1) |

CHART 12
Sample Microsoft Excel Codes used to derive the “CEND” flags by year

| | |
|---|---|
| 2001 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2002 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2003 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2004 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2005 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2006 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2007 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2008 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2009 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2010 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2011 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2012 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2013 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2014 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2015 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2016 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2017 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2018 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2019 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2020 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2021 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2022 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2023 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2024 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2025 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2026 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2027 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2028 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2029 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2030 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2031 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2032 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2033 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2034 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2035 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2036 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2037 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2038 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2039 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2040 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2041 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2042 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2043 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2044 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2045 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2046 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2047 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2048 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2049 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |
| 2050 | =IF(CEND_ON2,IF(SUM(CEND*HIT_S1)=1,IF(YEARS>=TRIGGER_1,0,1),IF(SUM |
| | (CEND*HIT_S2)=1,IF(YEARS>=TRIGGER_2,0,1),1)),1) |

### SUMMARY

The present invention not only provides a systematic and rigorous method of quantifying political risks and to quantify the true net worth of the investment. The method also provides crucial insights so that business managers can understand political risks and how those risks affect a project. With this information the business manager can explore way to mitigate those uncertainties. The present invention allows the creation of a historical record and database from which businesses can use to refine future political risk analysis. Also, maintaining a record is useful for making feasible a post audit of political risk analysis.

The scope of the present invention is not limited to the illustrated preferred embodiment, and many variations for different applications will be apparent to one skilled in the art.

What is claimed is:

1 A system for analyzing the value of a project which can account for the affect of political risks on the value of a project comprising:
means for inputting project economic value parameters into a data processing system;
means for inputting quantifications for categories of macro political risks into a said data processing system;
means for inputting quantifications of conditional probabilities for each project specific political risk event into said data processing system;
means for inputting changes to said project economic value parameters upon occurrence of risk events; and
means for calculating at least one risked project value metric for at least one instance of possible scenarios based upon a predetermined relationship of said macro political risks and said project specific political event risks with one or more project economic value parameters.

2. A system of claim 1 further comprising:
means for quantifying at least one category of said macro country risks;
means for quantifying at least one conditional project manifestation probability of said project specific political risk events; and
means for inputting the economic impact on at least one of said project economic parameter upon occurrence of at least one of said project specific risk events.

3. A system of claim 1 further comprising:
means for applying a probability equation to perform a predetermined number of iterations and to determine a risked project value metric for each iteration project.

4. A system of claim 1 further comprising:
means for applying a probability equation to determine multiple risked project value metrics for multiple iterations and generate a statistical distribution of said risked project value metrics.

5. A system of claim 1 further comprising:
means for selecting and deselecting project specific political risks to be included when determining a risked project value.

6. A system of claim 3 further comprising:
means to generate a statistical average said multiple risked project value metrics.

7. A system of claim 1 further comprising:
means to output changes in said risked project economic value parameters.

8. A system of claim 1 further comprising:
means to store said risked project value metrics.

9. A system of claim 1 further comprising:
means to store said project economic data parameters, said quantifications of categories of macro political risks, and said quantifications of conditional probabilities of manifestation of said projection specific political risk events.

10. A system of claim 6 further comprising:
means to compare unrisked project value metrics with risked project value metrics.

11. A system of claim 1 further comprising:
means to output the changes in said project economic value parameters resulting from the occurrence of a risk event.

12. A system of claim 1 further comprising:
means to quantify project conditional probabilities of manifestation of one or more of said project specific political risks with a multi-variant decision hierarchy scoring system.

13. A computer program for analyzing project value taking into account political risks comprising:
program code to receive input data for project economic value parameters, quantification for at least one category of macro political risk, quantification for at least one conditional probability of project specific political risk, and value changes for the affect of the occurrence of a risk event on one or more project economic value parameters; and
program code to calculate at least one risked project value for at least one instance of possible scenarios based upon a predetermined relationship of said macro political risks and said project specific risks with one or more said project value parameters.

14. A computer program of claim 13 further comprising:
program code to generate various statistical distributions and to calculate a plurality of iterations representing possible scenarios of risk events.

15. A computer program of claim 13 further comprising program code to quantify conditional probabilities of said project specific political risk using a multi-variant scoring system.

16. A method to evaluate project economics taking into account political risks comprising:
inputting into a data processing system economical data relating to a project valuation;
inputting into a data processing system quantification values for macro political risk categories;
inputting into a data processing system quantification values for project specific risk events;
inputting into a data processing system economic variances which occur when a risk event occurs; and
calculating the project value of at least one iteration of possible risk scenarios based upon a predetermined relationship of said macro political risks and said project specific risk events.

17. A method of claim 16 further comprising the outputting of said project value of at least one iteration of possible risk scenarios.

18. A method of claim 17 further comprising the storing of the inputted data and the calculated project values for various scenarios.

19. A method of claim 16 further comprising deselecting one or more of said project specific risk events from inclusion in calculating said project value to perform a sensitivity analysis of the project value to one or more of said project specific risk events.

20. A computer system for analyzing the value of a project which can account for the affect of political risks on the value of a project comprising:
one or more computer based machines; and
a computer program running on at least one of said computer-based machines, wherein said program receives data of the quantification of macro political risk categories, quantification of conditional probabilities of project specific risk events, baseline project economic data, project economic data associated with the occurrence of the occurrence of said project specific risk events, data to perform a probability analysis, and wherein said program can compute a predetermined number of iterations determining which risk events occurred and a project value for each of said iterations.

21. A computer system of claim 20 further wherein said computer program also receives data concerning the timing of different project phases, associates one or more of said macro political risks and project specific risk events with one or more said project phases.

22. A computer system of claim 20 further wherein said computer program also allows for the selection and deselection of said project specific risk events for inclusion in the calculation of said project value.

23. A computer readable medium comprising encoded instructions for causing a computer to function according to claim 16.

24. A system for analyzing the value of a project which can account for the affect of political risks on the value of a project comprising:
means for inputting project economic value parameters into a data processing system;
means for inputting quantifications of probalilities for the occurrence of categories of macro political risks for each defined sub period of the project into said data processing system;
means for inputting quantifications of conditional project manifestation probabilities for project specific political risks into said data processing system;
means for computing aggregate probalities of each project specific political risk for each sub-period of the project from said quantifications of probalilities for the occurrence of categories of macro political risks for each defined sub peiriod of the project and said quantifications of conditional project manifestation probabilities for project specific political risks;
means for inputting changes to said project economic value parameters upon occurrence of project specific political risk events;
means for generating at least one random number to generate an iteration for each random number generated to simulate one possible scenario of possible events,
means to determine the occurrence or non-occurrence of each of said project specific political risks events for each said iteration; and
means to calculate a risked project value metric for each said iteration resutling from said changes to said project economic value parameters upon occurrence of project specific political risk events by the occurrence or non-occurrence of each of said project specific political risks events for said iteration.

25. A system of claim 24 further comprising:
means to calculate on overall risked project value by from statictical analysis of all said risked project value metrics.

26. A system of claim 24 further comprising:
means to select and deselect the occurrence one of more of said project specific political risks from inclusion in the calculation of said risked project value metric.

27. A system for generating the simulation of possible senarios of risk events comprising:
means for inputting quantifications of probalilities for the occurrence of categories of macro political risks for each defined sub period of a project into a data processing system;
means for inputting quantifications of conditional project manifestation probabilities for project specific political risks into said data processing system;
means for computing aggregate probalities of each project specific political risk for each sub-period of the project from said quantifications of probalilities for the occurrence of categories of macro political risks for each defined sub peiriod of the project and said quantifications of conditional project manifestation probabilities for project specific political risks;
means for generating at least one random number to generate an iteration for each random number generated to simulate one possible scenario of possible events, means to determine the occurrence or non-occurrence of each of said project specific political risks events for each said iteration; and
means to generate flags indicating the occurrence or non-occurrence of each of said project specific political risks events for said iteration.

28. A system of claim 27 further comprising:
means to select and deselect the occurrence one of more of said project specific political risks from inclusion in the generation of said flags.
